(19) United States
(12) Patent Application Publication
(10) Pub. No.: US 2005/0165985 A1
(43) Pub. Date: Jul. 28, 2005

(54) Network protocol processor

(76) Inventors: Sriram R. Vangal, Portland, OR (US); Yatin Hoskote, Portland, OR (US); Vasantha K. Erraguntla, Beaverton, OR (US); Nitin Y. Borkar, Portland, OR (US)

Correspondence Address: KONRAD RAYNES & VICTOR, LLP, Suite 210, 315 S. Beverly Drive, Beverly Hills, CA, 90212, US

(21) Appl. No.: 10/747,919

(22) Filed: Dec. 29, 2003

(51) Int. Cl. G06F 13/00

(52) U.S. Cl. 710/107

(57) ABSTRACT

Disclosed are techniques for processing a packet. A packet is received. Context data for the packet is located in a storage area. The packet is processed using the context data. Also disclosed is a network protocol processor with an interface to receive a packet, a cache to store context data for the packet, and a processing engine to process the packet using context data in the cache. Moreover, the network protocol processor includes a working register to store the context data for a current connection that is being processed. Additionally, the cache is capable of storing and retrieving context data for multiple connections.

### REFERENCES TO RELATED APPLICATIONS

This application relates to the following co-pending application: NETWORK PROTOCOL ENGINE, attorney docket number 42.P14732, filed on ______ by Sriram R. Vangal et al.

### REFERENCE TO APPENDIX

This application includes an appendix, Appendix A, of micro-code instructions. The authors retain applicable copyright rights in this material.

### BACKGROUND

1. Field

The disclosure relates to a network protocol processor.

2. Description of the Related Art

Networks enable computers and other electronic devices to exchange data such as e-mail messages, web pages, audio data, video data, and so forth. Before transmission across a network, data is typically distributed across a collection of packets. A receiver can reassemble the data back into its original form after receiving the packets.

In addition to the data (“payload”) being sent, a packet also includes “header” information. A network protocol can define the information stored in the header, the packet's structure, and how processes should handle the packet.

Different network protocols handle different aspects of network communication. Many network communication models organize these protocols into different layers. For example, models such as the Transmission Control Protocol/Internet Protocol (TCP/IP) model (TCP—Internet Engineering Task Force (IETF) Request for Comments (RFC) 793, published September 1981; IP IETF RFC 791, published September 1981) and the Open Systems Interconnection (OSI) model (define a “physical layer” that handles bit-level transmission over physical media; a “link layer” that handles the low-level details of providing reliable data communication over physical connections; a “network layer”, such as the Internet Protocol, that can handle tasks involved in finding a path through a network that connects a source and destination; and a “transport layer” that can coordinate communication between source and destination devices while insulating “application layer” programs from the complexity of network communication.

A different network communication model, the Asynchronous Transfer Mode (ATM) model, is used in ATM networks. The ATM model also defines a physical layer, but defines ATM and ATM Adaption Layer (AAL) layers in place of the network, transport, and application layers of the TCP/IP and OSI models.

Generally, to send data over the network, different headers are generated for the different communication layers. For example, in TCP/IP, a transport layer process generates a transport layer packet (sometimes referred to as a “segment”) by adding a transport layer header to a set of data provided by an application; a network layer process then generates a network layer packet (e.g., an IP packet) by adding a network layer header to the transport layer packet; a link layer process then generates a link layer packet (also known as a “frame”) by adding a link layer header to the network packet; and so on. This process is known as encapsulation. By analogy, the process of encapsulation is much like stuffing a series of envelopes inside one another.

After the packet(s) travel across the network, the receiver can de-encapsulate the packet(s) (e.g., “unstuff” the envelopes). For example, the receiver's link layer process can verify the received frame and pass the enclosed network layer packet to the network layer process. The network layer process can use the network header to verify proper delivery of the packet and pass the enclosed transport segment to the transport layer process. Finally, the transport layer process can process the transport packet based on the transport header and pass the resulting data to an application.

As described above, both senders and receivers have quite a bit of processing to do to handle packets. Additionally, network connection speeds continue to increase rapidly. For example, network connections capable of carrying 10-gigabits per second and faster may soon become commonplace. This increase in network connection speeds imposes an important design issue for devices offering such connections. That is, at such speeds, a device may easily become overwhelmed with a deluge of network traffic. An overwhelmed device may become the site of a network “traffic jam” as packets await processing or the may even drop packets, causing further communication problems between devices.

Transmission Control Protocol (TCP) is a connection-oriented reliable protocol accounting for over 80% of network traffic. Today TCP processing is performed almost exclusively through software. Several studies have shown that even state-of-the-art servers are forced to completely dedicate their Central Processing Units (CPUs) to TCP processing when bandwidths exceed a few Gbps. At 10 Gbps, there are 14.8M minimum-size Ethernet packets arriving every second, with a new packet arriving every 67.2 ns. The term “Ethernet” is a reference to a standard for transmission of data packets maintained by the Institute of Electrical and Electronics Engineers (IEEE) and one version of the Ethernet standard is IEEE std. 802.3, published Mar. 8, 2002. Allowing a few nanoseconds for overhead, wire-speed TCP processing requires several hundred instructions to be executed approximately every 50 ns. Given that a majority of TCP traffic is composed of small packets, this is an overwhelming burden on the CPU. A generally accepted rule of thumb for network processing is that 1 GHz CPU processing frequency is required for a 1 Gbps Ethernet link. For smaller packet sizes on saturated links, this requirement is often much higher. Ethernet bandwidth is slated to increase at a much faster rate than the processing power of leading edge microprocessors. Therefore, general purpose MIPS may not be able to provide the required computing power in coming generations. Even with the advent of GHz processor speeds, there is a need for a dedicated TCP offload engine (TOE) in order to support high bandwidths of 10 Gbps and beyond.

Therefore, there is a need in the art for an improved network protocol processor.

### BRIEF DESCRIPTION OF THE DRAWINGS

Referring now to the drawings in which like reference numbers represent corresponding parts throughout:

FIG. 1 is a block diagram of a network protocol engine in accordance with certain embodiments.

FIG. 2 is a schematic of a network protocol engine in accordance with certain embodiments.

FIG. 3 is a schematic of a processor of a network protocol engine in accordance with certain embodiments.

FIG. 4 is a chart of an instruction set for programming network protocol operations in accordance with certain embodiments.

FIG. 5 is a diagram of a TCP (Transmission Control Protocol) state machine in accordance with certain embodiments.

FIGS. 6-10 illustrate operation of a scheme to track out-of-order packets in accordance with certain embodiments.

FIG. 11 is operations for a process to track out-of-order packets in accordance with certain embodiments.

FIGS. 12-13 are schematics of a system to track out-of-order that includes content addressable memory in accordance with certain embodiments.

FIG. 14 is a diagram of a network protocol engine featuring different clock signals in accordance with certain embodiments.

FIG. 15 is a diagram of a network protocol engine featuring a clock signal based on one or more packet characteristics in accordance with certain embodiments.

FIG. 16 is a diagram of a mechanism for providing a clock signal based on one or more packet characteristics in accordance with certain embodiments.

FIG. 17A illustrates a TOE as part of a computing device in accordance with certain embodiments.

FIGS. 17B and 17C illustrate a TOE with DMA capability in a single CPU system and a dual CPU system, respectively, in accordance with certain embodiments.

FIG. 18 illustrates a proof of concept version of a processing engine that can form the core of this TCP offload engine in accordance with certain embodiments.

FIGS. 19A and 19B illustrate graphs, respectively, that represent measurements against the proof of concept chip in accordance with certain embodiments.

FIG. 20 illustrates a format for a packet in accordance with certain embodiments.

FIG. 21 illustrates a network protocol processing system using a TOE in accordance with certain embodiments.

FIG. 22A illustrates a micro-system for an execution core of processing engine in accordance with certain embodiments.

FIG. 22B illustrates details of a pipelined Arithmetic Logic Unit (ALU) organization in accordance with certain embodiments.

FIG. 23 illustrates a TOE programming model in accordance with certain embodiments.

FIGS. 24A and 24C illustrate processing by the TOE for inbound and outbound packets, respectively, in accordance with certain embodiments.

FIGS. 24B and 24D illustrate operations for processing inbound and outbound packets, respectively, in accordance with certain embodiments.

FIGS. 25A and 25B illustrate a new TOE instruction set in accordance with certain embodiments.

FIGS. 26A and 26B illustrate TOE assisted DMA data transfer on packet receive and packet transmit in accordance with certain embodiments.

FIG. 27 illustrates one embodiment of a computing device.

### DETAILED DESCRIPTION OF THE EMBODIMENTS

In the following description, reference is made to the accompanying drawings which form a part hereof and which illustrate several embodiments. It is understood that other embodiments may be utilized and structural and operational changes may be made without departing from the scope of embodiments.

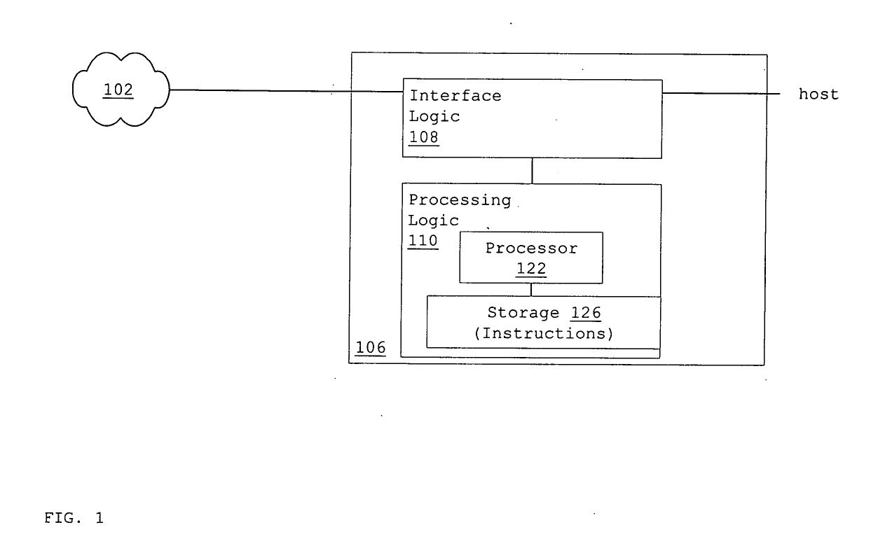

Many computing devices and other host devices feature processors (e.g., general purpose Central Processing Units (CPUs)) that handle a wide variety of tasks. Often these processors have the added responsibility of handling network traffic. The increases in network traffic and connection speeds have placed growing demands on host processor resources. To at least partially reduce the burden of network communication on a host processor, FIG. 1 depicts an example of a network protocol “off-load” engine 106 that can perform network protocol operations for a host in accordance with certain embodiments. The system 106 can perform operations for a wide variety of protocols. For example, the system can be configured to perform operations for transport layer protocols (e.g., TCP and User Datagram Protocol (UDP)), network layer protocols (e.g., IP), and application layer protocols (e.g., sockets programming). Similarly, in ATM networks, the system 106 can be configured to provide ATM layer or AAL layer operations for ATM packets (also referred to as “cells”). The system can be configured to provide other protocol operations such as those associated with the Internet Control Message Protocol (ICMP).

In addition to conserving host processor resources by handling protocol operations, the system 106 may provide “wire-speed” processing, even for very fast connections such as 10-gigabit per second and 40-gigabit per second connections. In other words, the system 106 may, generally, complete processing of one packet before another arrives. By keeping pace with a high-speed connection, the system 106 can potentially avoid or reduce the cost and complexity associated with queuing large volumes of backlogged packets.

The sample system 106 shown includes an interface 108 for receiving data traveling between one or more hosts and a network 102. For out-going data, the system 106 interface 108 receives data from the host(s) and generates packets for network transmission, for example, via a PHY and medium access control (MAC) device (not shown) offering a network connection (e.g., an Ethernet or wireless connection). For received packets (e.g., packets received via the PHY and MAC), the system 106 interface 108 can deliver the results of packet processing to the host(s). For example, the system 106 may communicate with a host via a Small Computer System Interface (SCSI) (American National Standards Institute (ANSI) SCSI Controller Commands-2 (SCC-2) NCITS.318:1998) or Peripheral Component Interconnect (PCI) type bus (e.g., a PCI-X bus system) (PCI Special Interest Group, PCI Local Bus Specification, Rev 2.3, published March 2002).

In addition to the interface 108, the system 106 also includes processing logic 110 that implements protocol operations. Like the interface 108, the logic 110 may be designed using a wide variety of techniques. For example, the system 106 may be designed as a hard-wired ASIC (Application Specific Integrated Circuit), a FPGA (Field Programmable Gate Array), and/or as another combination of digital logic gates.

As shown, the logic 110 may also be implemented by a system 106 that includes a processor 122 (e.g., a micro-controller or micro-processor) and storage 126 (e.g., ROM (Read-Only Memory) or RAM (Random Access Memory)) for instructions that the processor 122 can execute to perform network protocol operations. The instruction-based system 106 offers a high degree of flexibility. For example, as a network protocol undergoes changes or is replaced, the system 106 can be updated by replacing the instructions instead of replacing the system 106 itself. For example, a host may update the system 106 by loading instructions into storage 126 from external FLASH memory or ROM on the motherboard, for instance, when the host boots.

Though FIG. 1 depicts a single system 106 performing operations for a host, a number of off-load engines 106 may be used to handle network operations for a host to provide a scalable approach to handling increasing traffic. For example, a system may include a collection of engines 106 and logic for allocating connections to different engines 106. To conserve power, such allocation may be performed to reduce the number of engines 106 actively supporting on-going connections at a given time.

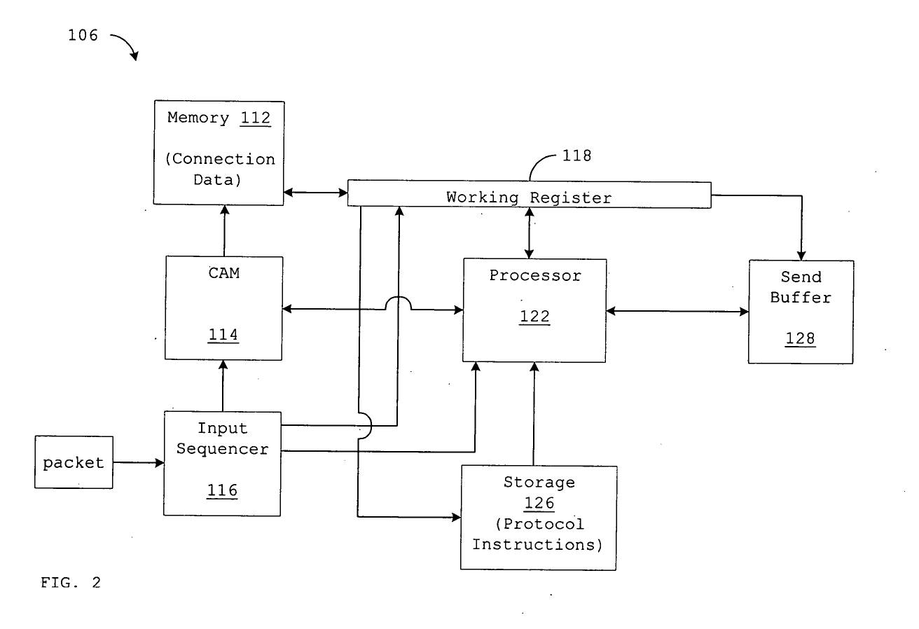

FIG. 2 depicts a sample embodiment of a system 106 in accordance with certain embodiments. As an overview, in this embodiment, the system 106 stores context data for different connections in a memory 112. For example, for the TCP protocol, this data is known as TCB (Transmission Control Block) data. For a given packet, the system 106 looks-up the corresponding connection context in memory 112 and makes this data available to the processor 122, in this example, via a working register 118. Using the context data, the processor 122 executes an appropriate set of protocol embodiment instructions from storage 126. Context data, potentially modified by the processor 122, is then returned to the context memory 112.

In greater detail, the system 106 shown includes an input sequencer 116 that parses a received packet's header(s) (e.g., the TCP and IP headers of a TCP/IP packet) and temporarily buffers the parsed data. The input sequencer 116 may also initiate storage of the packet's payload in host accessible memory (e.g., via DMA (Direct Memory Access)). As described below, the input sequencer 116 may be clocked at a rate corresponding to the speed of the network connection.

As described above, the system 106 stores context data for different network connections. To quickly retrieve context data from memory 112 for a given packet, the system 106 depicted includes a content-addressable memory 114 (CAM) that stores different connection identifiers (e.g., index numbers) for different connections as identified, for example, by a combination of a packet's IP source and destination addresses and source and destination ports. A CAM can quickly retrieve stored data based on content values much in the way a database can retrieve records based on a key. Thus, based on the packet data parsed by the input sequencer 116, the CAM 114 can quickly retrieve a connection identifier and feed this identifier to the context data memory 112. In turn, the connection context data corresponding to the identifier is transferred from the memory 112 to the working register 118 for use by the processor 122.

In the case that a packet represents the start of a new connection (e.g., a CAM 114 search for a connection fails), the working register 118 is initialized (e.g., set to the “LISTEN” state in TCP) and CAM 114 and a context data entries are allocated for the connection, for example, using a Least Recently Used (LRU) algorithm or other allocation scheme.

The number of data lines connecting different components of the system 106 may be chosen to permit data transfer between connected components 112-128 in a single clock cycle. For example, if the context data for a connection includes n-bits of data, the system 106 may be designed such that the connection data memory 112 may offer n-lines of data to the working register 118.

Thus, the sample embodiment shown uses at most three processing cycles to load the working register 118 with connection data: one cycle to query the CAM 114; one cycle to access the connection data 112; and one cycle to load the working register 118. This design can both conserve processing time and economize on power-consuming access to the memory structures 112, 114.

After retrieval of connection data for a packet, the system 106 can perform protocol operations for the packet, for example, by processor 122 execution of protocol embodiment instructions stored in storage 126. The processor 122 may be programmed to “idle” when not in use to conserve power. After receiving a “wake” signal (e.g., from the input sequencer 116 when the connection context is retrieved or being retrieved), the processor 122 may determine the state of the current connection and identify the starting address of instructions for handling this state. The processor 122 then executes the instructions beginning at the starting address. Depending on the instructions, the processor 122 can alter context data (e.g., by altering working register 118), assemble a message in a send buffer 128 for subsequent network transmission, and/or may make processed packet data available to the host (not shown). Again, context data, potentially modified by the processor 122, is returned to the context data memory 112.

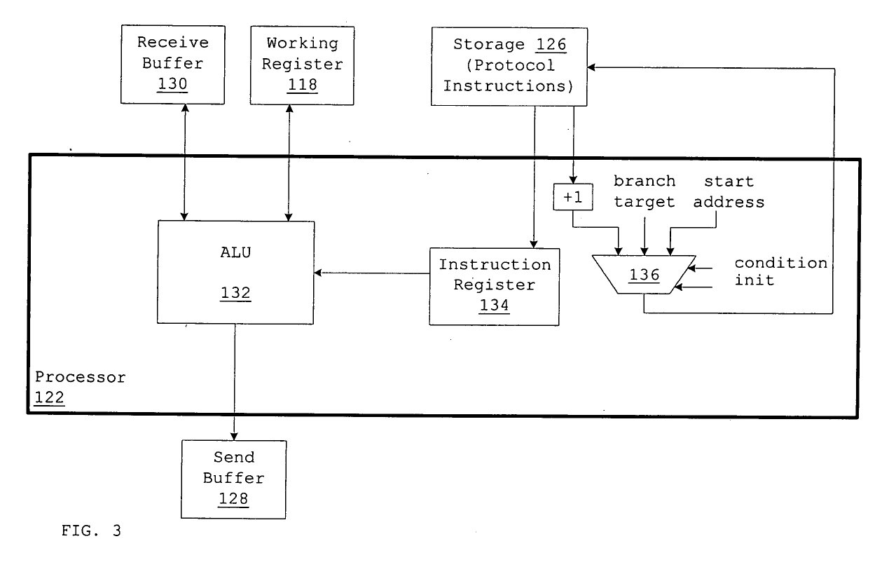

FIG. 3 depicts the processor 122 in greater detail in accordance with certain embodiments. As shown, the processor 122 may include an Arithmetic Logic Unit (ALU) 132 that decodes and executes micro-code instructions loaded into an instruction register 134. The instructions in storage 126 may be loaded 136 into the instruction register 134 from storage 126 in sequential succession with exceptions for branching instructions and start address initialization. The instructions from storage 126 may specify access (e.g., read or write access) to a receive buffer 130 that stores the parsed packet data, the working register 118, the send buffer 128, and/or host memory (not shown). The instructions may also specify access to scratch memory, miscellaneous registers (e.g., registers dubbed R0, cond, and statusok), shift registers, and so forth (not shown). For programming convenience, the different fields of the send buffer 128 and working register 118 may be assigned labels for use in the instructions. Additionally, various constants may be defined, for example, for different connection states. For example, “LOAD TCB[state], LISTEN” instructs the processor 122 to change the state of the connection context state in the working register 118 to the “LISTEN” state.

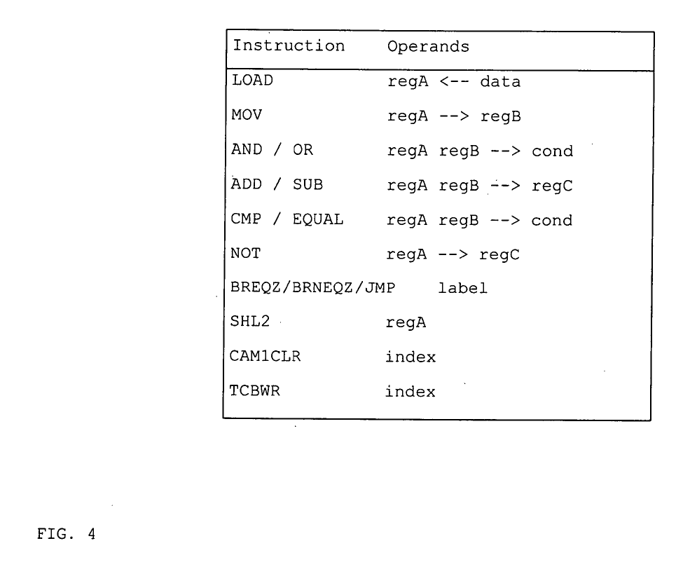

FIG. 4 depicts an example of a micro-code instruction set that can be used to program the processor to perform protocol operations in accordance with certain embodiments. As shown, the instruction set includes operations that move data within the system (e.g., LOAD and MOV), perform mathematic and Boolean operations (e.g., AND, OR, NOT, ADD, SUB), compare data (e.g., CMP and EQUAL), manipulate data (e.g., SHL (shift left)), and provide branching within a program (e.g., BREQZ (conditionally branch if the result of previous operation equals zero), BRNEQZ (conditionally branch if result of previous operation does not equal zero), and JMP (unconditionally jump)).

The instruction set also includes operations specifically tailored for use in implementing protocol operations with system 106 resources. These instructions include operations for clearing the CAM 114 of an entry for a connection (e.g., CAM1CLR) and for saving context data to the context data storage 112 (e.g., TCBWR). Other embodiments may also include instructions that read and write identifier information to the CAM 114 storing data associated with a connection (e.g., CAM1READ key→index and CAM1WRITE key→index) and an instruction that reads the context data (e.g., TCBRD index→destination). Alternately, these instructions may be implemented as hard-wired logic.

Though potentially lacking many instructions offered by traditional general purpose CPUs (e.g., processor 122 may not feature instructions for floating-point operations), the instruction set provides developers with easy access to system 106 resources tailored for network protocol embodiment. A programmer may directly program protocol operations using the micro-code instructions. Alternately, the programmer may use a wide variety of code development tools (e.g., a compiler or assembler).

As described above, the system 106 instructions can implement operations for a wide variety of network protocols. For example, the system 106 may implement operations for a transport layer protocol such as TCP. A complete specification of TCP and optional extensions can be found in IETF RFCs 793, 1122, and 1323.

Briefly, TCP provides connection-oriented services to applications. That is, much like picking up a telephone and assuming the phone company makes everything work, TCP provides applications with simple primitives for establishing a connection (e.g., CONNECT and CLOSE) and transferring data (e.g., SEND and RECEIVE). TCP transparently handles communication issues such as data retransmission, congestion, and flow control.

To provide these services to applications, TCP operates on packets known as segments. A TCP segment includes a TCP header followed by one or more data bytes. A receiver can reassemble the data from received segments. Segments may not arrive at their destination in their proper order, if at all. For example, different segments may travel very different paths across a network. Thus, TCP assigns a sequence number to each data byte transmitted. Since every byte is sequenced, each byte can be acknowledged to confirm successful transmission. The acknowledgment mechanism is cumulative so that an acknowledgment of a particular sequence number indicates that bytes up to that sequence number have been successfully delivered.

The sequencing scheme provides TCP with a powerful tool for managing connections. For example, TCP can determine when a sender should retransmit a segment using a technique known as a “sliding window”. In the “sliding window” scheme, a sender starts a timer after transmitting a segment. Upon receipt, the receiver sends back an acknowledgment segment having an acknowledgement number equal to the next sequence number the receiver expects to receive. If the sender's timer expires before the acknowledgment of the transmitted bytes arrives, the sender transmits the segment again. The sequencing scheme also enables senders and receivers to dynamically negotiate a window size that regulates the amount of data sent to the receiver based on network performance and the capabilities of the sender and receiver.

In addition to sequencing information, a TCP header includes a collection of flags that enable a sender and receiver to control a connection. These flags include a SYN (synchronize) bit, an ACK (acknowledgement) bit, a FIN (finish) bit, a RST (reset) bit. A message including a SYN bit of “1” and an ACK bit of “0” (a SYN message) represents a request for a connection. A reply message including a SYN bit “1” and an ACK bit of “1” (a SYN+ACK message) represents acceptance of the request. A message including a FIN bit of “1” indicates that the sender seeks to release the connection. Finally, a message with a RST bit of “1” identifies a connection that should be terminated due to problems (e.g., an invalid segment or connection request rejection).

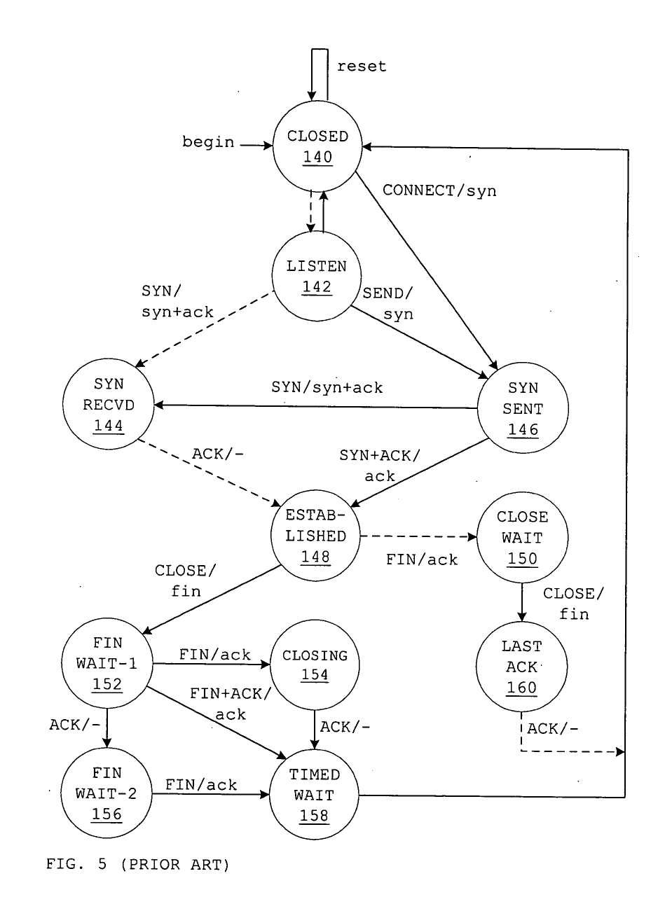

FIG. 5 depicts a state diagram representing different stages in the establishment and release of a TCP connection in accordance with certain embodiments. The diagram depicts different states 140-160 and transitions (depicted as arrowed lines) between the states 140-160. The transitions are labeled with corresponding event/action designations that identify an event and an action required to move to a subsequent state 140-160. For example, after receiving a SYN message and responding with a SYN+ACK message, a connection moves from the LISTEN state 142 to the SYN RCVD state 144.

In the state diagram of FIG. 5, the typical path for a sender (a TCP entity requesting a connection) is shown with solid transitions while the typical paths for a receiver is shown with dotted line transitions in accordance with certain embodiments. To illustrate operation of the state machine, a receiver typically begins in the CLOSED state 140 that indicates no connection is currently active or pending. After moving to the LISTEN 142 state to await a connection request, the receiver receives a SYN message requesting a connection and acknowledges the SYN message with a SYN+ACK message and enter the SYN RCVD state 144. After receiving acknowledgement of the SYN+ACK message, the connection enters an ESTABLISHED state 148 that corresponds to normal on-going data transfer. The ESTABLISHED state 148 may continue for some time. Eventually, assuming no reset message arrives and no errors occur, the server receives and acknowledge a FIN message and enter the CLOSE WAIT state 150. After issuing its own FIN and entering the LAST ACK state 160, the server receives acknowledgment of its FIN and finally return to the original CLOSED 140 state.

Again, the state diagram also manages the state of a TCP sender. The sender and receiver paths share many of the same states described above. However, the sender may also enter a SYN SENT state 146 after requesting a connection, a FIN WAIT 1 state 152 after requesting release of a connection, a FIN WAIT 2 state 156 after receiving an agreement from the receiver to release a connection, a CLOSING state 154 where both sender and receiver request release simultaneously, and a TIMED WAIT state 158 where previously transmitted connection segments expire.

The system's 106 protocol instructions may implement many, if not all, of the TCP operations described above and in the RFCs. For example, the instructions may include procedures for option processing, window management, flow control, congestion control, ACK message generation and validation, data segmentation, special flag processing (e.g., setting and reading URGENT and PUSH flags), checksum computation, and so forth. The protocol instructions may also include other operations related to TCP such as security support, random number generation, RDMA (Remote Direct Memory Access) over TCP, and so forth.

In a system 106 configured to provide TCP operations, the context data may include 264-bits of information per connection including: 32-bits each for PUSH (identified by the micro-code label “TCB[pushseq]”), FIN (“TCB[finseq]”), and URGENT (“TCB[rupseq]”) sequence numbers, a next expected segment number (“TCB[rnext]”), a sequence number for the currently advertised window (“TCB[cwin]”), a sequence number of the last unacknowledged sequence number (“TCB[suna]”), and a sequence number for the next segment to be next (“TCB[snext]”). The remaining bits store various TCB state flags (“TCB[flags]”), TCP segment code (“TCB[code]”), state (“TCB[tcbstate]”), and error flags (“TCB[error]”),

To illustrate programming for a system 106 configured to perform TCP operations, Appendix A features an example of source micro-code for a TCP receiver. Briefly, the routine TCPRST checks the TCP ACK bit, initializes the send buffer, and initializes the send message ACK number. The routine TCPACKIN processes incoming ACK messages and checks if the ACK is invalid or a duplicate. TCPACKOUT generates ACK messages in response to an incoming message based on received and expected sequence numbers. TCPSEQ determines the first and last sequence number of incoming data, computes the size of incoming data, and checks if the incoming sequence number is valid and lies within a receiving window. TCPINITCB initializes TCB fields in the working register. TCPINITWIN initializes the working register with window information. TCPSENDWIN computes the window length for inclusion in a send message. Finally, TCBDATAPROC checks incoming flags, processes “urgent”, “push” and “finish” flags, sets flags in response messages, and forwards data to an application or user.

Another operation performed by the system 106 may be packet reordering. For example, like many network protocols, TCP does not assume TCP packets (“segments”) arrive in order. To correctly reassemble packets, a receiver can keep track of the last sequence number received and await reception of the byte assigned the next sequence number. Packets arriving out-of-order can be buffered until the intervening bytes arrive. Once the awaited bytes arrive, the next bytes in the sequence can potentially be retrieved quickly from the buffered data.

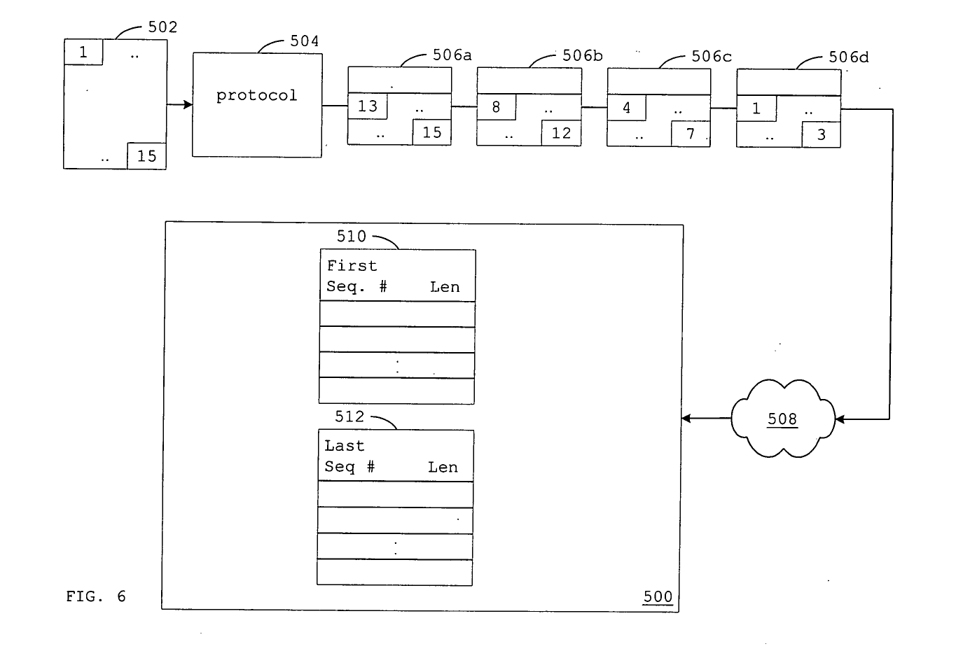

FIGS. 6-10 illustrate operation of a scheme to track out-of-order packets that can be implemented by the system 106 in accordance with certain embodiments. The scheme permits quick “on-the-fly” ordering of packets without employing a traditional sorting algorithm. The scheme may be implemented using another set of content-addressable memory 510, 512, though this is not a requirement. Thus, a system 106 using this technique may include two different sets of content-addressable memory—the content-addressable memory 114 used to retrieve connection context data and the content-addressable memory used to track out-of-order packets.

For the purposes of illustration, FIGS. 6-10 are discussed in the context of an embodiment of TCP in accordance with certain embodiments. However, the scheme has wide applicability to a variety of packet re-ordering schemes such as numbered packets (e.g., protocol data unit fragments). Thus, while the description below discusses storage of TCP sequence numbers, an embodiment for numbered packets can, instead, store packet numbers.

Briefly, when a packet arrives, a packet tracking sub-system determines whether the received packet is in-order. If not, the sub-system consults memory to identify a contiguous set of previously received out-of-order packets bordering the newly arrived packet and can modify the data stored in the memory to add the packet to the set. When a packet arrives in-order, the sub-system can access the memory to quickly identify a contiguous chain of previously received packets that follow the newly received packet.

In greater detail, as shown in FIG. 6, a protocol 504 (e.g., TCP) divides a set of data 502 into a collection of packets 506a-506d for transmission over a network 508. In the example shown, 15-bytes of an original set of data 502 are distributed across the packets 506a-506d. For example, packet 506d includes bytes assigned sequence numbers “1” to “3”.

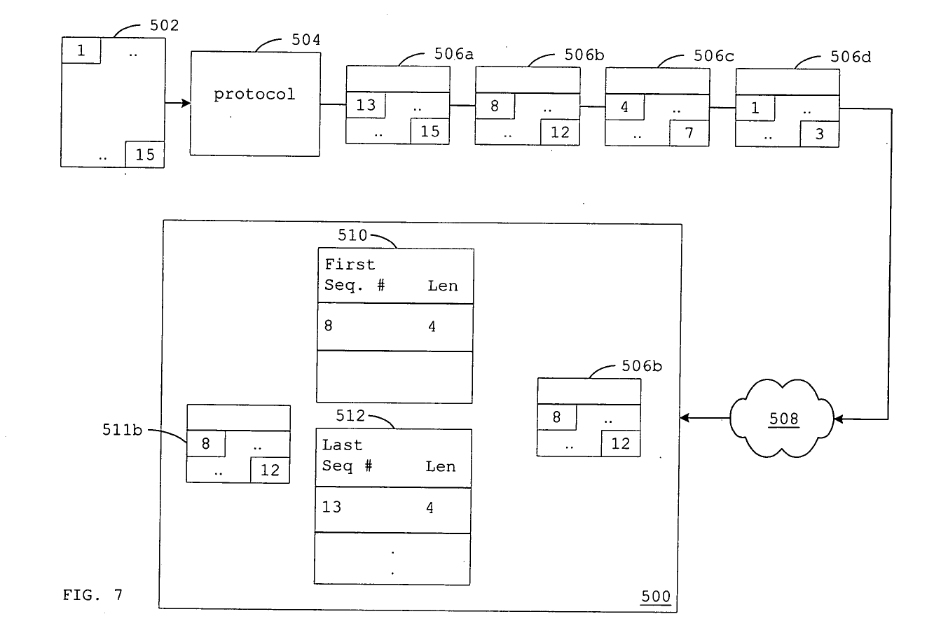

As shown, the tracking sub-system 500 includes content-addressable memory 510, 512 that stores information about received, out-of-order packets. Memory 510 stores the first sequence number of a contiguous chain of one or more out-of-order packets and the length of the chain. Thus, when a new packet arrives that ends where the pre-existing chain begins, the new packet can be added to the top of the pre-existing chain. Similarly, the memory 512 also stores the end (the last sequence number+1) of a contiguous packet chain of one or more packets and the length of the chain. Thus, when a new packet arrives that begins at the end of a previously existing chain, the new packet can be appended to the end of the previously existing chain to form an even larger chain of contiguous packets. To illustrate these operations, FIGS. 7-10 depict a sample series of operations that occur as the packets 506a-506d arrive in accordance with certain embodiments.

As shown in FIG. 7, packet 506b arrives carrying bytes with sequence numbers “8” through “12”. Assuming the sub-system 500 currently awaits sequence number “1”, packet 506b has arrived out-of-order. Thus, as shown, the device 500 tracks the out-of-order packet 506b by modifying data stored in its content-addressable memory 510, 512. The packet 506b does not border a previously received packet chain as no chain yet exists in this example. Thus, the sub-system 500 stores the starting sequence number, “8”, and the number of bytes in the packet, “4”. The sub-system 500 also stores identification of the end of the packet. In the example shown, the device 500 stores the ending boundary by adding one to the last sequence number of the received packet (e.g., 12+1=13). In addition to modifying or adding entries in the content-addressable memory 510, 512, the device 500 can store the packet or a reference (e.g., a pointer) to the packet 511b to reflect the relative order of the packet. This permits fast retrieval of the packets when finally sent to an application.

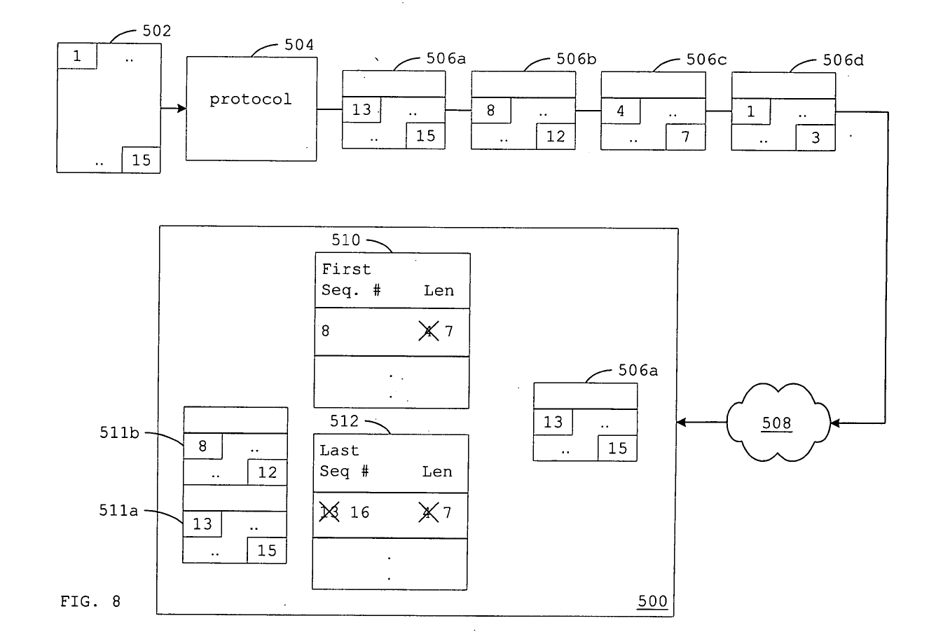

As shown in FIG. 8, the sub-system 500 next receives packet 506a carrying bytes “13” through “15”. Again, the sub-system 500 still awaits sequence number “1”. Thus, packet 506a has also arrived out-of-order. The sub-system 500 examines memory 510, 512 to determine whether the received packet 506a borders any previously stored packet chains. In this case, the newly arrived packet 506a does not end where a previous chain begins, but does begin where a previous chain ends. In other words, packet 506a borders the “bottom” of packet 506b. As shown, the device 500 can merge the packet 506a into the pre-existing chain in the content-addressable memory data by increasing the length of the chain and modifying its first and last sequence number data accordingly. Thus, the first sequence number of the new chain remains “8” though the length is increased from “4” to “7”, while the end sequence number of the chain is increased from “13” to “16” to reflect the bytes of the newly received packet 506a. The device 500 also stores the new packet 511a or a reference to the new packet to reflect the relative ordering of the packet.

As shown in FIG. 9, the device 500 next receives packet 506c carrying bytes “4” to “7”. Since this packet 506c does not include the next expected sequence number, “1”, the device 500 repeats the process outlined above. That is, the device 500 determines that the newly received packet 506c fits “atop” the packet chain spanning packets 506b, 506a. Thus, the device 500 modifies the data stored in the content-addressable memory 510, 512 to include a new starting sequence number for the chain, “4”, and a new length data for the chain, “11”. The device 500 again stores a reference to the packet 511c data to reflect the packet's 511c relative ordering.

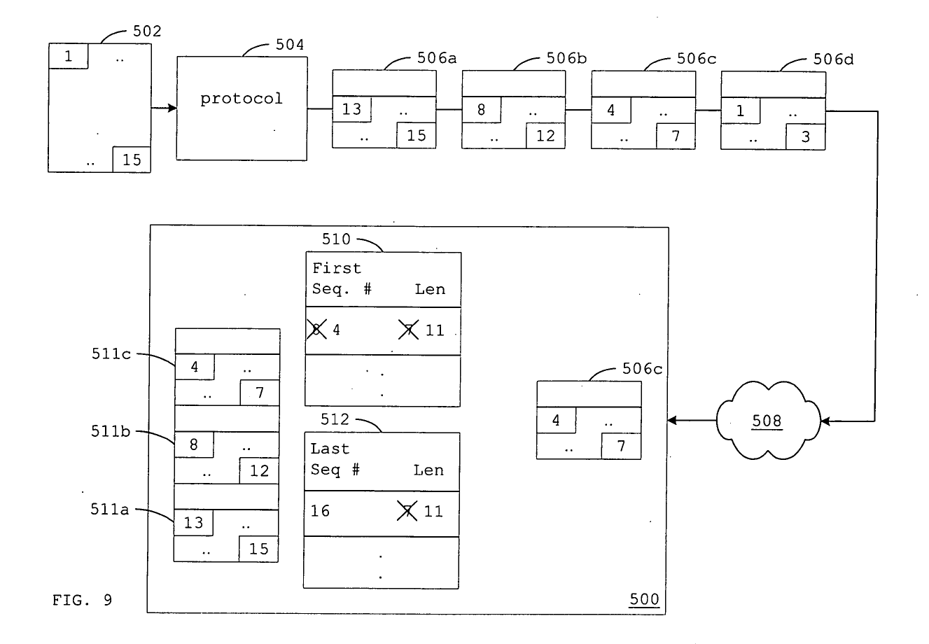

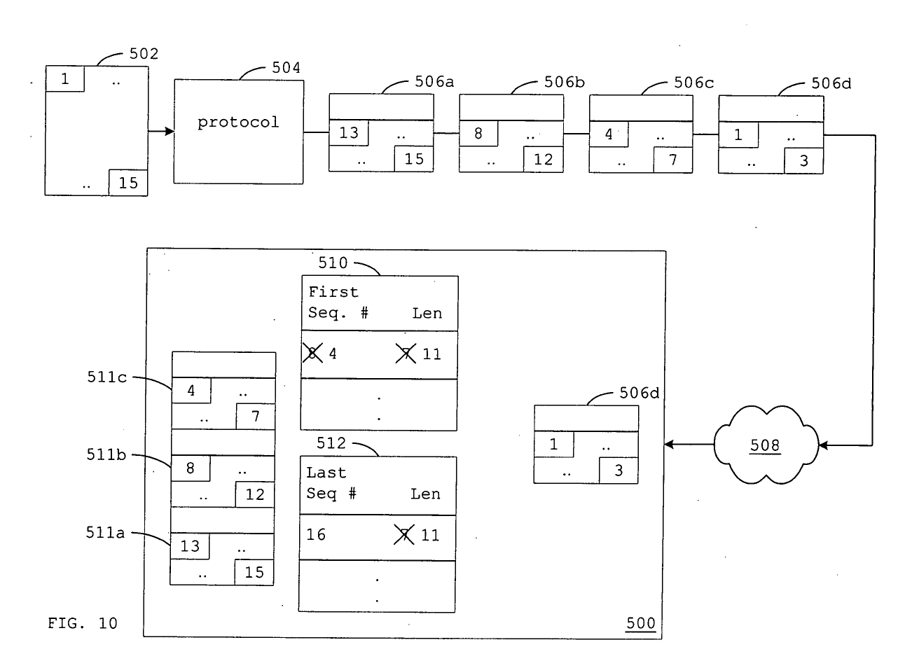

As shown in FIG. 10, the device 500 finally receives packet 506d that includes the next expected sequence number, “1”. The device 500 can immediately transfer this packet 506d to an application. The device 500 can also examine its content-addressable memory 510 to see if other packets can also be sent to the application. In this case, the received packet 506d borders a packet chain that already spans packets 506a-506c. Thus, the device 500 can immediately forward the data of chained packets to the application in the correct order.

The sample series shown in FIGS. 7-10 highlights several aspects of the scheme. First, the scheme may prevent out-of-order packets from being dropped and being retransmitted by the sender. This can improve overall throughput. The scheme also uses very few content-addressable memory operations to handle out-of-order packets, saving both time and power. Further, when a packet arrives in the correct order, a single content-addressable memory operation can identify a series of contiguous packets that can also be sent to the application.

FIG. 11 depicts operations for a process 520 for implementing the scheme illustrated above in accordance with certain embodiments. As shown, after receiving 522 a packet, the process 520 determines 524 if the packet is in-order (e.g., whether the packet includes the next expected sequence number). If not, the process 520 determines 532 whether the end of the received packet borders the start of an existing packet chain. If so, the process 520 can modify 534 the data stored in content-addressable memory to reflect the larger, merged packet chain starting at the received packet and ending at the end of the previously existing packet chain. The process 520 also determines 536 whether the start of the received packet borders the end of an existing packet chain. If so, the process 520 can modify 538 the data stored in content-addressable memory to reflect the larger, merged packet chain ending with the received packet.

Potentially, the received packet may border pre-existing packet chains on both sides. In other words, the newly received packet fills a hole between two chains. Since the process 520 checks both starting 532 and ending 536 borders of the received packet, a newly received packet may cause the process 520 to join two different chains together into a single monolithic chain.

As shown, if the received packet does not border a packet chain, the process 520 stores 540 data in content-addressable memory for a new packet chain that, at least initially, includes only the received packet.

If the received packet is in-order, the process 520 can query 526 the content-addressable memory to identify a bordering packet chain following the received packet. If such a chain exists, the process 520 can output the newly received packet to an application along with the data of other packets in the adjoining packet chain.

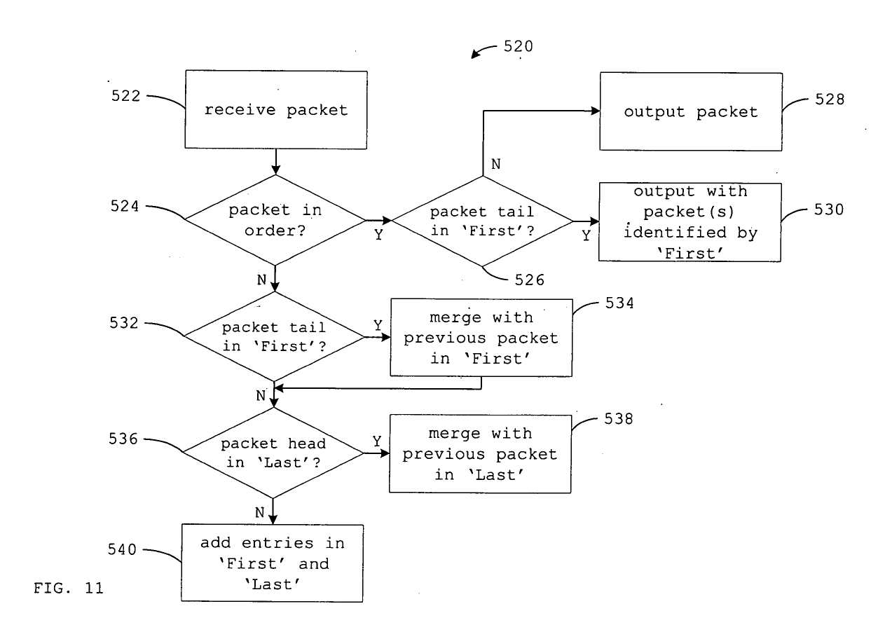

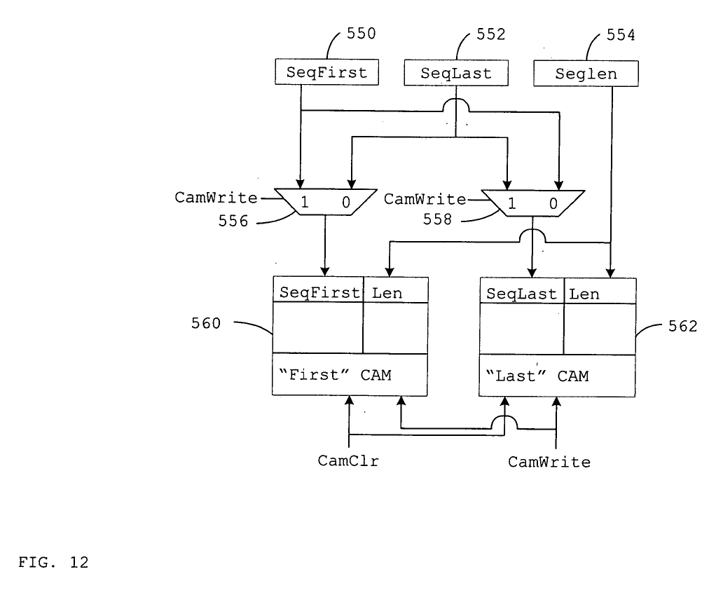

This process may be implemented using a wide variety of hardware, firmware, and/or software. For example, FIGS. 12 and 13 depict a hardware embodiment of the scheme describe above in accordance with certain embodiments. As shown in these figures, the embodiment features two content-addressable memories 560, 562—one 560 stores the first sequence number of an out-of-order packet chain as the key and the other 562 stores the last+1 sequence number of the chain as the key. As shown, both CAMs 560, 562 also store the length of chain. Other embodiments my use a single CAM. Still other embodiments use address based memory or other data storage instead of content-addressable memory. Potentially, the same CAM(s) 560, 562 can be used to track packets of many different connections. In such cases, a connection ID may be appended to each CAM entry as part of the key to distinguish entries for different connections. The merging of packet information into chains in the CAM(s) 560, 562 permits the handling of more connections with smaller CAMs 560, 562. As shown in FIG. 12, the embodiment includes registers that store a starting sequence number 550, ending sequence number 552, and a data length 554. The processor 122 shown in FIG. 2 may access these registers 550, 552, 554 to communicate with the sub-system 500. For example, the processor 122 can load data of a newly received packet into the sub-system 500 data. The processor 122 may also request a next expected sequence number to include in an acknowledgement message sent back to the sender.

As shown, the embodiment operates on control signals for reading from the CAM(s) 560, 562 (CAMREAD), writing to the CAMs 560, 562 (CAMWRITE), and clearing a CAM 560, 562 entry (CAMCLR). As shown in FIG. 12, the hardware may be configured to simultaneously write register values to both CAMs 560, 562 when the registers 550, 552, 554 are loaded with data. As shown in FIG. 13, for “hits” for a given start or end sequence number, the circuitry sets the “seglen” register to the length of a matching CAM entry. Circuitry (not shown) may also set the values of the “seqfirst” 550 and “seqlast” 552 registers after a successful CAM 560, 562 read operation. The circuitry may also provide a “CamIndex” signal that identifies a particular “hit” entry in the CAM(s) 560, 562.

To implement the packet tracking approach described above, the sub-system 500 may feature its own independent controller that executes instructions implementing the scheme or may feature hard-wired logic. Alternately, a processor 122 (FIG. 1) may include instructions for the scheme. Potentially, the processor 122 instruction set (FIG. 4) may be expanded to include commands that access the sub-system 500 CAMs 560, 562. Such instructions may include instructions to write data to the CAM(s) 560, 562 (e.g., CAM2FirstWR key←data for CAM 510 and CAM2LastWR key←data for CAM 512); instructions to read data from the CAM(s) (e.g., CAM2FirstRD key→data and CAM2LastRD key→data); instructions to clear CAM entries (e.g., CAM2CLR key), and/or instructions to generate a condition value if a lookup failed (e.g., CAM2EMPTY→cond).

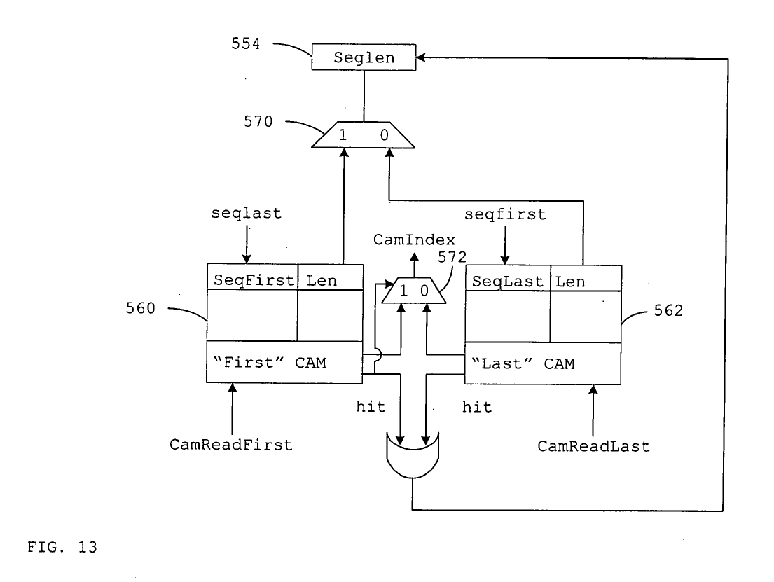

Referring to FIG. 14, potentially, the interface 108 and processing 110 logic components may be clocked at the same rate in accordance with certain embodiments. A clock signal essentially determines how fast a logic network operates. Unfortunately, due to the fact that many instructions may be executed for a given packet, to operate at wire-speed, the system 106 might be clocked at a very fast rate far exceeding the rate of the connection. Running the entire system 106 at a single very fast clock can both consume a tremendous amount of power and generate high temperatures that may affect the behavior of heat-sensitive silicon.

Instead, as shown in FIG. 14, components in the interface 108 and processing 110 logic may be clocked at different rates. As an example, the interface 108 components may be clocked at a rate, “1×”, corresponding to the speed of the network connection. Since the processing logic 110 may be programmed to execute a number of instructions to perform appropriate network protocol operations for a given packet, processing logic 110 components may be clocked at a faster rate than the interface 108. For example, components in the processing logic 110 may be clocked at some multiple “k” of the interface 108 clock frequency where “k” is sufficiently high to provide enough time for the processor 122 to finish executing instructions for the packet without falling behind wire speed. Systems 106 using the “dual-clock” approach may feature devices known as “synchronizers” (not shown) that permit differently clocked components to communicate.

As an example of a “dual-clock” system, for a system 106 having an interface 108 data width of 16-bits, to achieve 10 gigabits per second, the interface 108 should be clocked at a frequency of 625 MHz (e.g., [16-bits per cycle]×[625,000,000 cycles per second]=10,000,000,000 bits per second). Assuming a smallest packet of 64 bytes (e.g., a packet only having IP and TCP headers, frame check sequence, and hardware source and destination addresses), it may take the 16-bit/625 MHz interface 108 32-cycles to receive the packet bits. Potentially, an inter-packet gap may provide additional time before the next packet arrives. If a set of up to n instructions is used to process the packet and a different instruction can be executed each cycle, the processing block 110 may be clocked at a frequency of k·(625 MHz) where k=n-instructions/32-cycles. For embodiment convenience, the value of k may be rounded up to an integer value or a value of 2ⁿ though neither of these is a strict requirement.

Since components run by a faster clock generally consume greater power and generate more heat than the same components run by a slower clock, clocking the different components 108, 110 at different speeds according to their need can enable the system 106 to save power and stay cooler. This can both reduce the power requirements of the system 106 and can reduce the need for expensive cooling systems.

Power consumption and heat generation can be reduced even further. That is, the system 106 depicted in FIG. 14 featured system 106 logic components clocked at different, fixed rates determined by “worst-case” scenarios to ensure that the processing block 110 keeps pace with wire-speed. As such, the smallest packets that require the quickest processing acted as a constraint on the processing logic 110 clock speed. In practice, however, a large number packets feature larger packet sizes and afford the system 106 more time for processing before the next packet arrives.

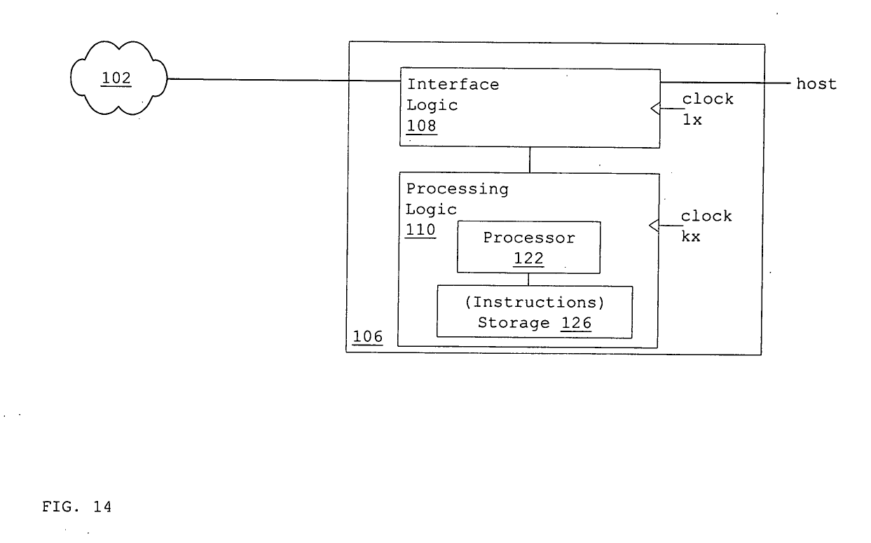

Thus, instead of permanently tailoring the system 106 to handle difficult scenarios, FIG. 15 depicts a system 106 that provides a clock signal to processing logic 110 components at frequencies that can dynamically vary based on one or more packet characteristics in accordance with certain embodiments. For example, a system 106 may use data identifying a packet's size (e.g., the length field in the IP datagram header) to scale the clock frequency. For instance, for a bigger packet, the processor 122 has more time to process the packet before arrival of the next packet, thus, the frequency could be lowered without falling behind wire-speed. Likewise, for a smaller packet, the frequency may be increased. Adaptively scaling the clock frequency “on the fly” for different incoming packets can reduce power by reducing operational frequency when processing larger packets. This can, in turn, result in a cooler running system that may avoid the creation of silicon “hot spots” and/or expensive cooling systems.

As shown in FIG. 15, scaling logic 124 receives packet data and correspondingly adjusts the frequency provided to the processing logic 110. While discussed above as operating on the packet size, a wide variety of other metrics may be used to adjust the frequency such as payload size, quality of service (e.g., a higher priority packet may receive a higher frequency), protocol type, and so forth. Additionally, instead of the characteristics of a single packet, aggregate characteristics may be used to adjust the clock rate (e.g., average size of packets received). To save additional power, the clock may be temporarily disabled when the network is idle.

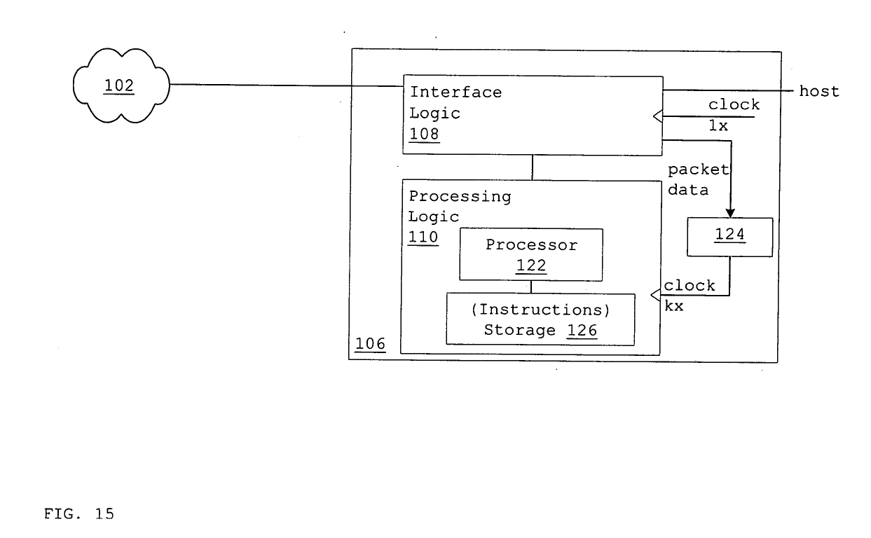

The scaling logic 124 may be implemented in wide variety of hardware and/or software schemes. For example, FIG. 16 depicts a hardware scheme that uses dividers 408a-408c to offer a range of available frequencies (e.g., 32×, 16×, 8×, and 4×) in accordance with certain embodiments. The different frequency signals are fed into a multiplexer 410 for selection based on packet characteristics. For example, a selector 412 may feature a magnitude comparator that compares packet size to different pre-computed thresholds. For example, a comparator may use different frequencies for packets up to 64 bytes in size (32×), between 64 and 88 bytes (16×), between 88 and 126 bytes (8×), and 126 to 236 bytes (4×). These thresholds may be determined such that the processing logic clock frequency satisfies the following equation:
[(packet size/data-width)/interface-clock-frequency]>=(interface-clock-cycles/interface-clock-frequency)+(maximum number of instructions/processing-clock-frequency).

While FIG. 16 illustrates four different clocking signals, other embodiments may feature n-clocking signals. Additionally, the relationship between the different frequencies provided need not be uniform fractions of one another as shown in FIG. 16.

The resulting clock signal can be routed to different components within the processing logic 110. However, not all components within the processing logic 110 and interface 108 blocks need to run at the same clock frequency. For example, in FIG. 2, while the input sequencer 116 receives a “1×” clock signal and the processor 122 receives a “kx” clock signal”, the connection data memory 112 and CAM 114 may receive the “1×” or the “kx” clock signal, depending on the embodiment.

Placing the scaling logic 124 physically near a frequency source can reduce power consumption. Further, adjusting the clock at a global clock distribution point both saves power and reduces logic need to provide clock distribution.

Again, a wide variety of embodiments may use one or more of the techniques described above. Additionally, the system 106 may appear in a variety of forms. For example, the system 106 may be designed as a single chip. Potentially, such a chip may be included in a chipset or on a motherboard. Further, the system 106 may be integrated into components such as a network adaptor, NIC (Network Interface Card), or MAC (medium access device). Potentially, techniques described herein may integrated into a micro-processor.

A system 106 may also provide operations for more than one protocol. For example, a system 106 may offer operations for both network and transport layer protocols. The system 106 may be used to perform network operations for a wide variety of hosts such as storage switches and application servers.

Certain embodiments provide a network protocol processing system to implement protocol (e.g., TCP) input and output processing. The network protocol processing system is capable of processing packet receives and transmits at, for example, 10+Gbps Ethernet traffic at a client computer or a server computer. The network protocol processing system minimizes buffering and queuing by providing line-speed (e.g., TCP/IP) processing for packets (e.g., packets larger than 512 bytes). That is, the network protocol processing system is able to expedite the processing of inbound and outbound packets.

The network protocol processing system provides a programmable solution to allow for extensions or changes in the protocol (e.g., extensions to handle emerging protocols, such as Internet Small Computer Systems Interface (iSCSI) (IETF RFC 3347, published February 2003) or Remote Direct Memory Access (RDMA)). The network protocol processing system also provides a new instruction set. The network protocol processing system also uses multi-threading to effectively hide memory latency. Although examples herein may refer to TCP, embodiments are applicable to other protocols.

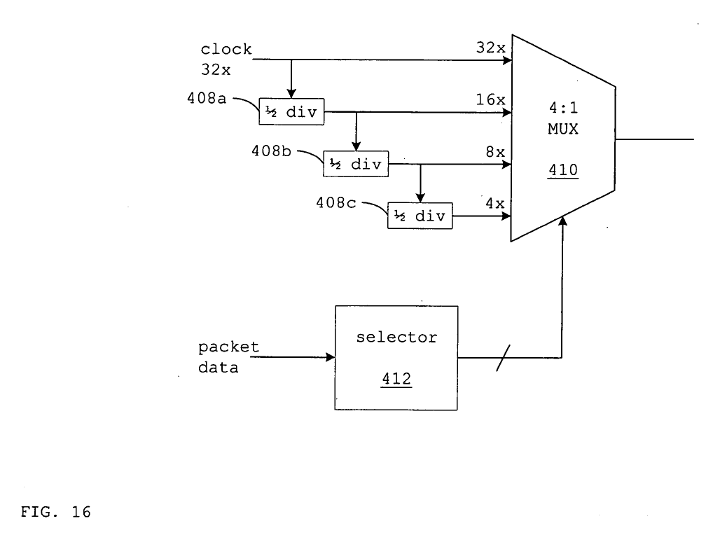

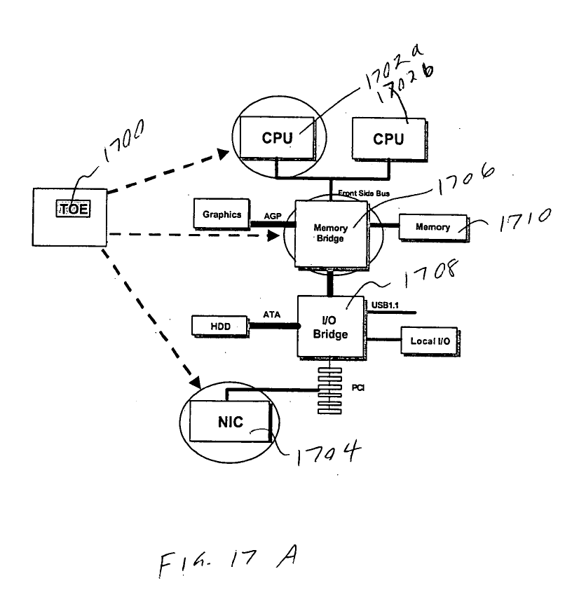

Certain embodiments provide a TCP Offload Engine (TOE) to offload some of processing from the CPU. FIG. 17A illustrates a TOE as part of a computing device in accordance with certain embodiments. The computing device includes multiple CPUs 1702a, 1702b connected via a memory bridge 1706 and an I/O bridge 1708 to a network interface controller (NIC) 1704. In various embodiments, the TOE 1700 may be implemented in a CPU 1702a or 1702b, NIC 1704 or memory bridge 1706 as hardware. In certain embodiments, the TOE as part of the memory bridge 1706 provides better access to host memory 1710.

FIGS. 17B and 17C illustrate a TOE with DMA capability in a single CPU system and a dual CPU system, respectively, in accordance with certain embodiments. In FIG. 17B, a chipset 1720 includes a TOE 1722 connected to a DMA engine 1724. The chipset 1720 is connected to a CPU 1726, host memory 1728, and NIC 1730. In FIG. 17C, there are multiple CPUs 1732a, 1732b connected to chipset 1720. In various embodiments, the TOE may be hardware that is physically part of the CPU 1726, 1732a or b 1732b, the chipset 1720 or the NIC 1730. In certain embodiments, the TOE as part of the chipset 1720 provides better access to host memory 1728. To allow direct transfer of data and to avoid certain intermediate buffering on both packet receives and transmits, the TOE 1722 has access to an integrated DMA engine 1724. This low latency transfer is useful for emerging direct placement protocols, such as Direct Memory Access (DMA) and RDMA.

In addition to high-speed protocol processing requirements, the efficient handling of Ethernet traffic involves addressing several issues at the system level, such as transfer of payload and management of CPU interrupts. Thus in certain embodiments, a high-speed processing engine is incorporated with a DMA controller and other hardware assist blocks, as well as system level optimizations.

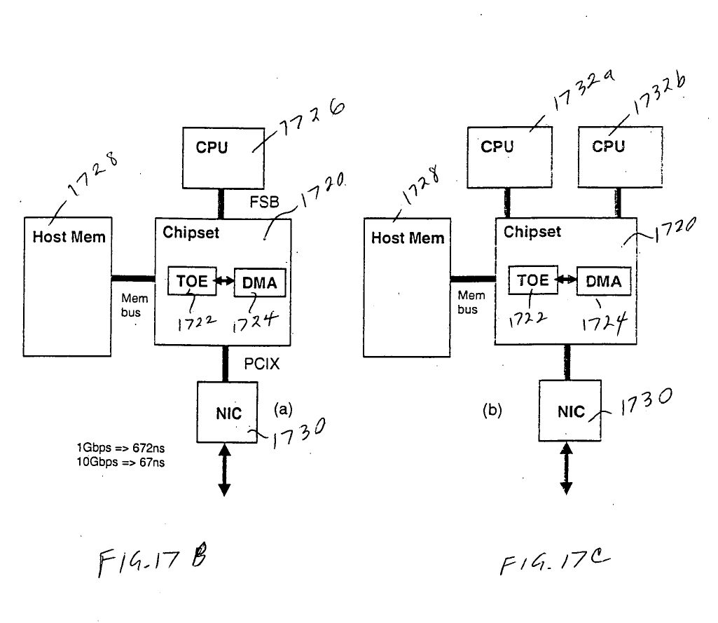

FIG. 18 illustrates a proof of concept version of a processing engine that can form the core of a TCP offload engine in accordance with certain embodiments. In FIG. 18, an experimental chip 1800 is illustrated that handles wire-speed inbound processing at 10 Gbps on a saturated wire with minimum size packets. The TOE is designed in this example as a special purpose processor targeted at packet processing. In order to adapt quickly to changing protocols, the chip 1800 is programmable. This approach also simplified the design of the chip 1800 and reduced the validation phase as compared to fixed state machine architectures. Additionally, the specialized instruction set provided by embodiments (and discussed below) reduces the processing time per packet. Chip 1800 includes an execution core, a Transmission Control Block (TCB), an input sequencer, a send buffer, a Read Only Memory (ROM), a Phase locked loop (PLL) circuit, a Context Lookup Block (CLB), and a Re-Order Block (ROB). Also, in certain embodiments, the chip area may be 2.23×3.54 mm². The chip process may be a 90 nm dual V_{T} CMOS. The interconnect may be 1 poly with 7 metals. The transistors may be 460K. The pad count may be 306.

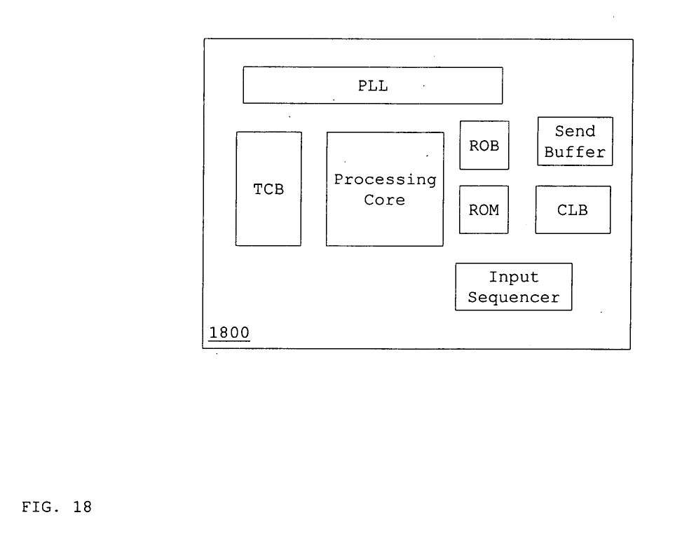

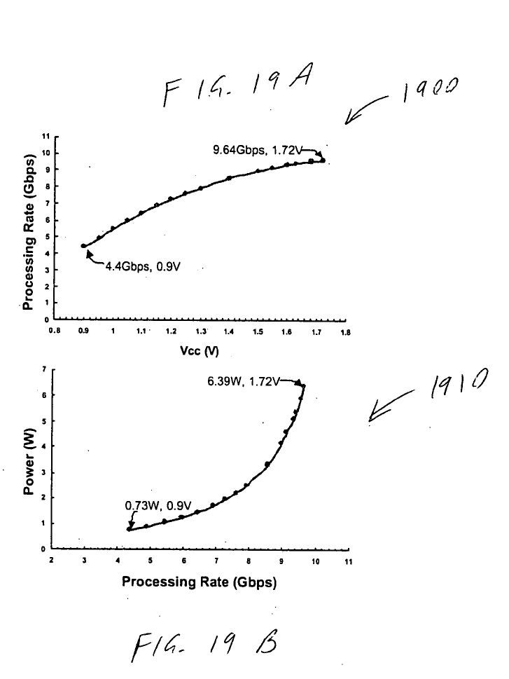

FIGS. 19A and 19B illustrate graphs 1900 and 1910, respectively, that represent measurements against the proof of concept chip 1800 in accordance with certain embodiments. With chip 1800, it is possible to scale down a high-speed execution core without any re-design, if the processing requirements (e.g., in terms of Ethernet bandwidth or minimum packet size) are relaxed. In FIG. 19A, the graph 1900 illustrates processing rate in Gbps versus vcc. Vcc may be described as a power supply name and stands for positive Direct Current (DC) terminal. Vss is the corresponding ground name. In FIG. 19B, the graph 1910 illustrates processing rate in Gbps versus power in Watts. Graphs 1900 and 1910 illustrate that TCP input processing capability exceeds 9 Gbps for chip 1800.

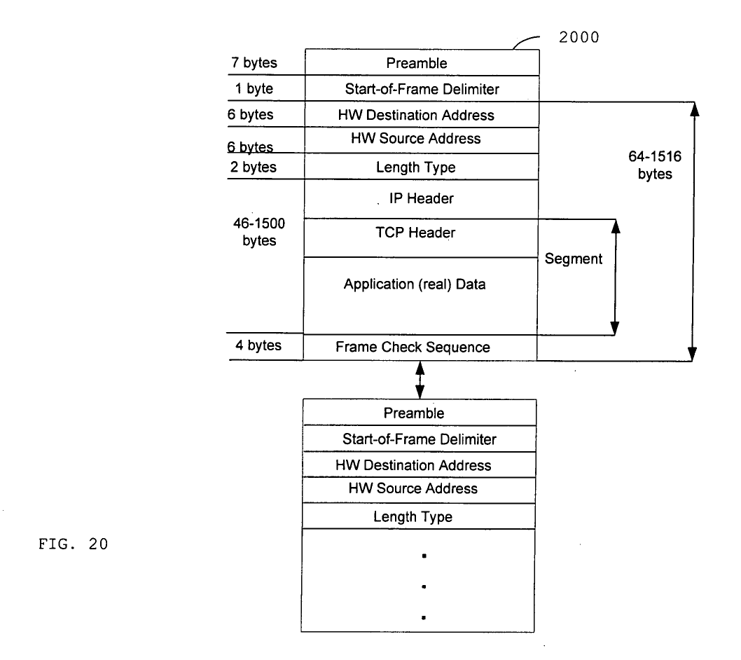

FIG. 20 illustrates a format for a packet 2000 in accordance with certain embodiments. The packet 2000 may have a Media Access Controller (MAC) frame format for transmission and receipt across an Ethernet connection. The packet 2000 includes MAC, IP, and TCP headers and associated payload data (if any). Upon completion of MAC level and IP layer processing by the NIC, the packet is forwarded for TCP layer and above processing to the network protocol processor.

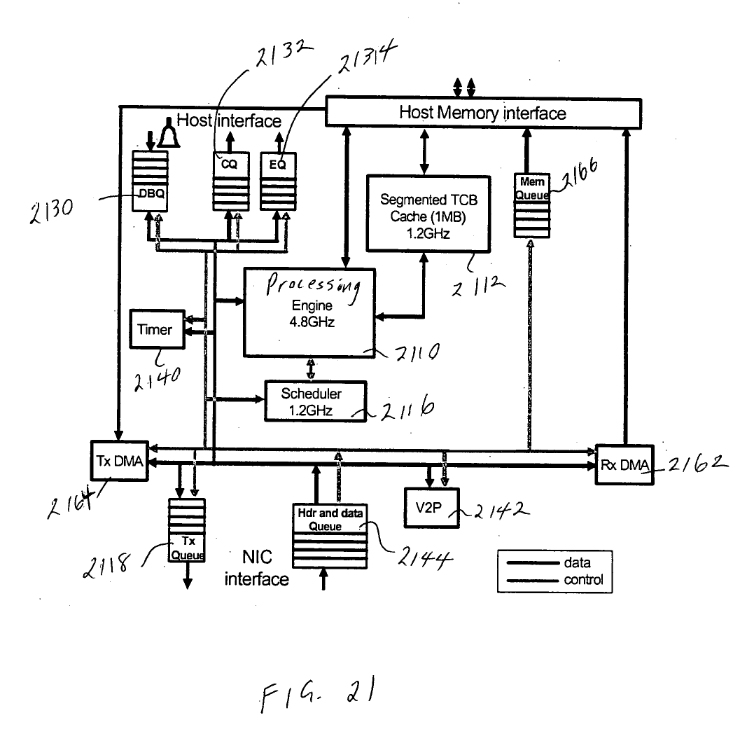

FIG. 21 illustrates a network protocol processing system using a TOE in accordance with certain embodiments. The network protocol processing system includes interfaces to the NIC, host memory, and the host CPU. The term “host” is used to refer to a computing device. The network protocol processing system uses a high speed processing engine 2210, with interfaces to the peripheral units. A dual frequency design is used, with the processing engine 2210 clocked several times faster (core clock) than the peripheral units (slow clock). This approach results in minimal input buffering needs, enabling wire-speed processing.

An on-die cache 2112 (i.e., a type of storage area) (e.g., 1MB) stores TCP connection context, which provides temporal locality for connections (e.g., 2K connections), with additional contexts residing in host memory. The context is the portion of the transmission control block (TCB) that TCP maintains for each connection. Caching this context on-chip is useful for 10 Gbps performance. The cache 2112 size may be limited by physical area. Although the term cache may be used herein, embodiments are applicable to any type of storage area.

In addition, to avoid intermediate packet copies on receives and transmits, an integrated direct memory access (DMA) engine (shown logically as a transfer (TX) DMA 2164 and receive (RX) DMA 2162) is provided. This enables a low latency transfer path and supports direct placement of data in application buffers without substantial intermediate buffering. The TX DMA 2164 transfers data from host memory to the transfer queue 2118 upon receiving a notification from the processing engine 2110 to perform the transfer. The RX DMA 2162 is capable of storing data from the header and data queue 2144 into host memory.

A central scheduler 2116 provides global control to the processing engine 2110 at a packet level granularity. In certain embodiments, a control store of the processing engine 2110 may be made cacheable. Caching code instructions allows code relevant to specific processing to be cached, with the remaining instructions in host memory and allows for protocol code changes.

An network interface interacts with a transmit queue 2118 (TX queue) that buffers outbound packets and a header and data queue 2144 that buffers incoming packets. Three queues form a hardware mechanism to interface with the host CPU. The host interface interacts with the following three queues: an inbound doorbell queue (DBQ) 2130, outbound completion queue (CQ) 2132, and an exception/event queue (EQ) 2134. Each queue 2130, 2132, 2134 may include a priority mechanism. The inbound doorbell queue (DBQ) 2130 initiates send (or receive) requests. An operating system may use the TOE driver layer 2300 to place doorbell descriptors in the DBQ 2130. The outbound completion queue (CQ) 2132 and the exception/event queue (EQ) 2134 communicate processed results and events back to the host. For example, a pass/fail indication may be stored in CQ 2132.

A timer unit 2140 provides hardware offload for four of seven frequently used timers associated with TCP processing. The system includes hardware assist for virtual to physical (V2P) 2142 address translation. A memory queue 2166 may also be included to queue data for the host interface.

The DMA engine supports 4 independent, concurrent channels and provides a low-latency/high throughput path to/from memory. The TOE constructs a list of descriptors (e.g., commands for read and write), programs the DMA engine, and initiates the DMA start operation. The DMA engine transfers data from source to destination as per the list. Upon completion of the commands, the DMA engine notifies the TOE, which updates the CQ 2132 to notify the host.

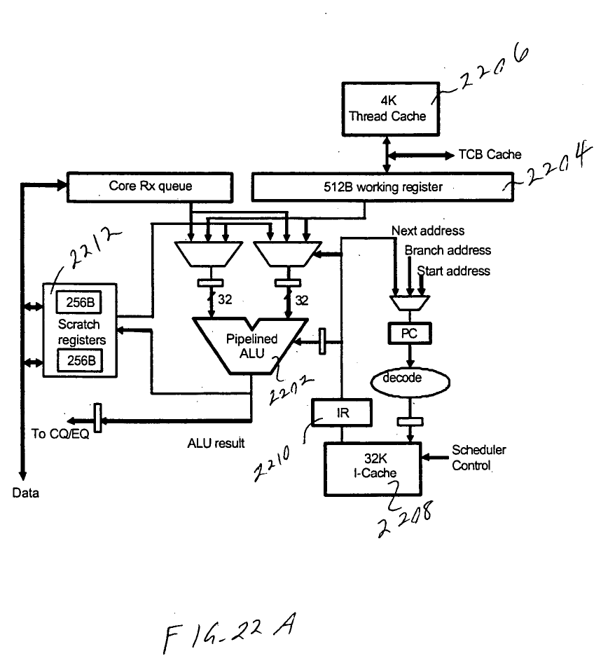

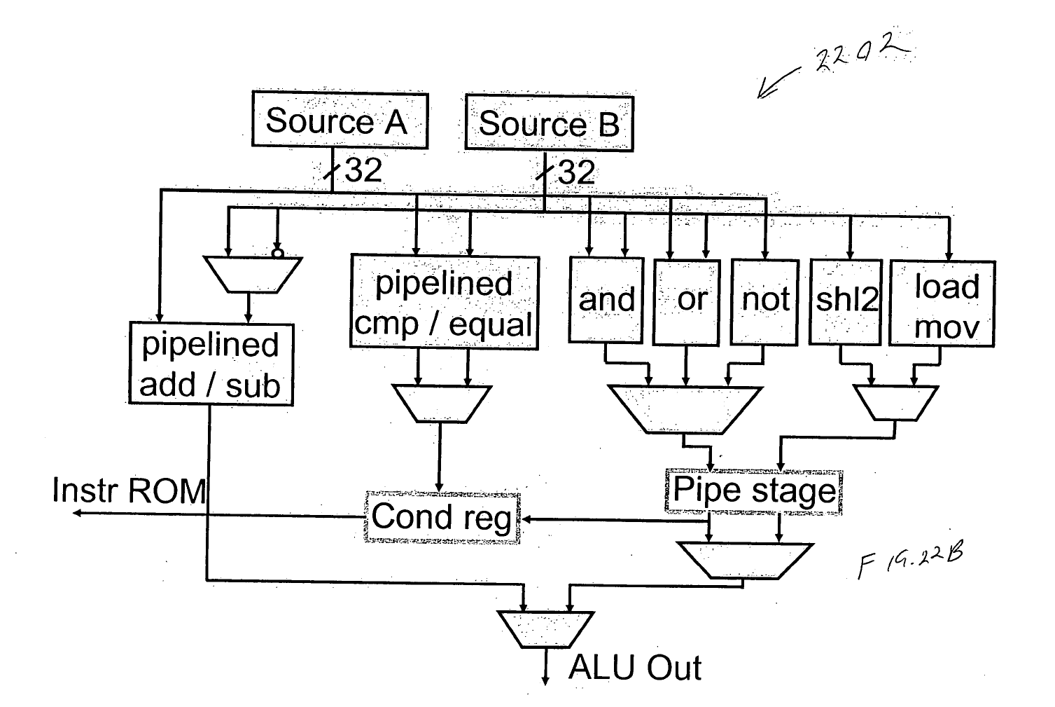

FIG. 22A illustrates a micro-system for an execution core 2200 of processing engine 2210 in accordance with certain embodiments. The processing engine 2210 includes a high-speed fully pipelined Arithmetic Logic Unit (ALU) , which communicates with a wide (e.g., 512 B) working register 2204. In certain embodiments, the working register is a subset of cache 2112. TCB context for the current scheduled active connection is loaded into the working register 2204 for processing. The execution core 2200 performs TCP processing under direction of instructions issued by the instruction cache (I-Cache) 2208. Instruction cache 2208 is a cacheable control store. A control instruction is read every execution core cycle and loaded into the instruction register (IR) 2210. The execution core 2200 reads instructions from the IR 2210, decodes them, if necessary, and executes them every cycle.

The functional units include arithmetic and logic units, shifters and comparators, which are optimized for high frequency operation. A register set 2212 includes a large register set. In certain embodiments, the register set 2212 includes two 256B register arrays to store intermediate processing results. The scheduler 2116 (FIG. 21) exercises additional control over execution flow.

In an effort to hide host and TCB memory latency and improve throughput, the processing engine 2110 is multithreaded. The processing engine 2110 includes a thread cache 2206, running at execution core speed, which allows intermediate system state to be saved and restored. The design also provides a high-bandwidth connection between the thread cache 2106 and the working register 2204, making possible very fast and parallel transfer of thread state between the working register 2204 and the thread cache 2206. Thread context switches may occur during both receives and transmits and when waiting on outstanding memory requests or on pending DMA transactions. Specific multi-threading details are described below.

The processing engine 2110 features a cacheable control store 2208 (FIG. 22A), which enables code relevant to specific TCP processing to be cached, with the rest of the code in host memory. A replacement policy allows TCP code in the instruction cache 2208 to be swapped as required. This also provides flexibility and allows for easy protocol updates.

FIG. 22B illustrates details of a pipelined ALU 2202 organization in accordance with certain embodiments. The ALU 2202 performs add, subtract, compare, and logical operations in parallel. The result of the ALU 2202 is written back to an appropriate destination register or send buffer that is enabled. In this illustration, the adder in the ALU 2202 is pipelined, which is split between the second and third pipe stages.

FIG. 23 illustrates a TOE programming model in accordance with certain embodiments. In FIG. 23, a user mode includes a user level Application Programming Interface (API) layer, and a kernel mode includes a kernel/transport driver layer. Below these layers, there is a TOE driver layer 2300 and a TOE 2310. Below these layers, is the NIC hardware, which includes an Internet Protocol (IP) layer, and a MAC/Physical (PHY) layer. The TOE 2000 may interact with the TOE driver 2300 via, for example, a queuing interface (e.g., DBQ 2130, CQ 2132, and EQ 2134 in FIG. 21). Also, as part of a chipset, the TOE may interact with the NIC. A kernel-level transport API supports legacy “null processing” bypass of the receive 2144 and transmit 2118 queues. Although queues may be described in examples herein, embodiments are operable to any type of data structure. Additionally, each data structure may incorporate a priority mechanism (e.g., First In First Out).

After a packet is processed, process results are updated to the working register 2204. Additionally, the cache 2112 and thread cache 2206 are updated with the results in the working register 2204.

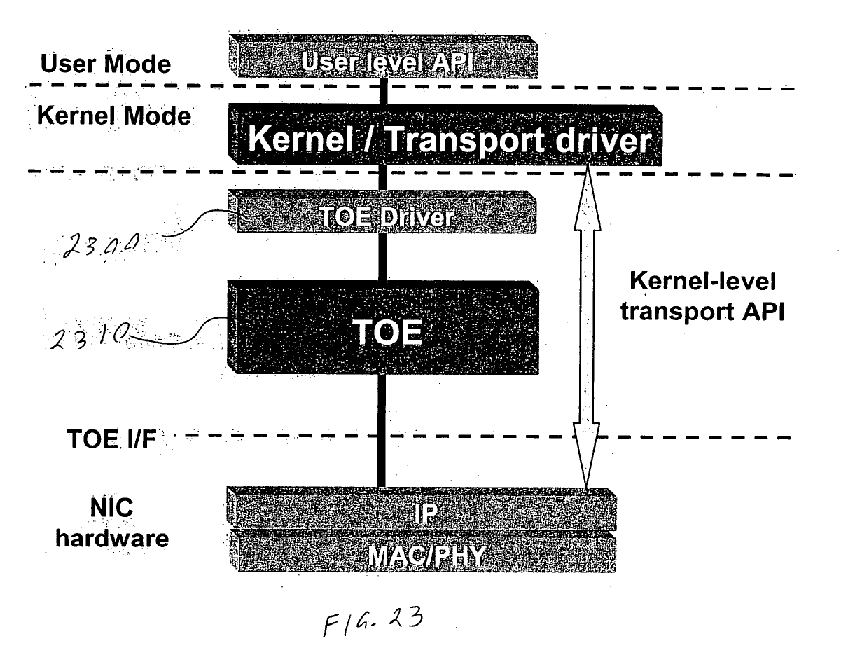

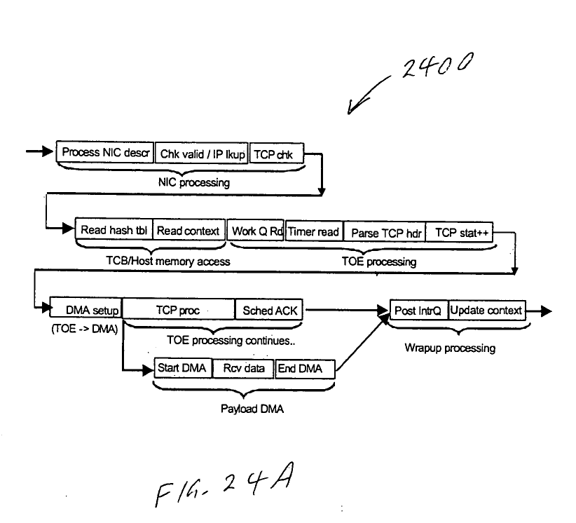

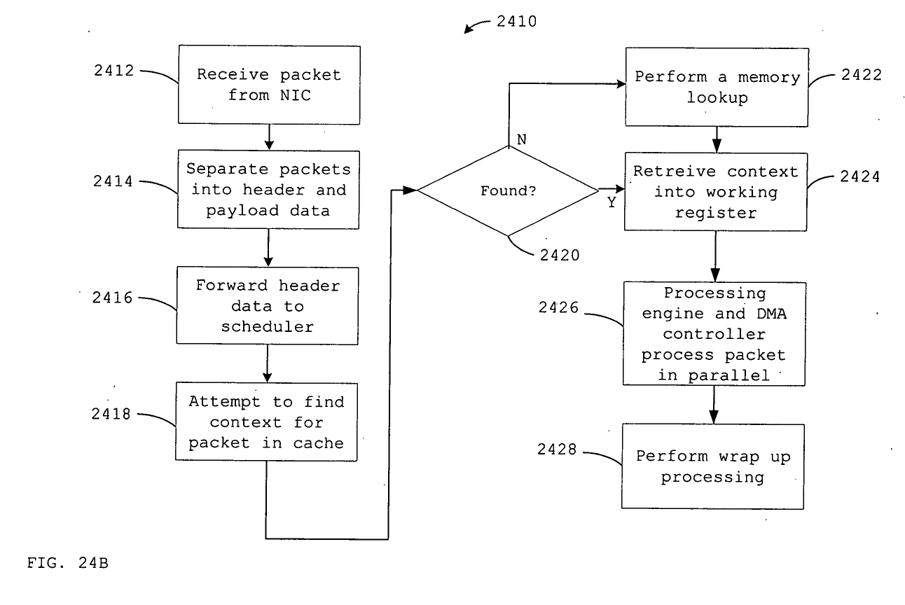

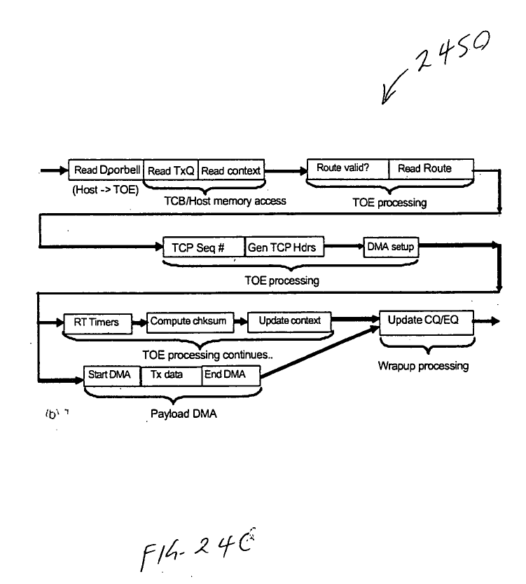

FIG. 24A illustrates processing by the TOE for inbound packets in accordance with certain embodiments. The inbound packets from the NIC are buffered in header and payload queue 2144 (i.e., the receive queue). A splitter (not shown) parses the inbound packet to separate packet payload from the header and forwards the header to the scheduler 2116. The scheduler 2116 performs a hash based table lookup against the cache 2112 using, for example, header descriptors, to correlate a packet with a connection. When the scheduler 2116 finds a context in the cache 2112 (i.e., “a cache hit”), the scheduler 2116 loads the context into the working register 2204 in the execution core 2200. When the scheduler 2116 does not find the context in the cache 2112 (i.e., “a cache miss”), the scheduler 2116 queues a host memory lookup, and the found context is loaded into the working register 2204. When a context is loaded into the working register 2204, execution core 2200 processing is started.

In certain embodiments, the processing engine 2110 performs TCP input processing under programmed control at high speed. The execution core 2200 also programs the DMA control unit and queues the receive DMA requests. Payload data is transferred from internal receive buffers to pre-posted locations in host memory using DMA. This low latency DMA transfer is useful for high performance. Careful design allows the TCP processing to continue in parallel with the DMA operation. On completion of TCP processing, the context is updated with the processing results and written back to the cache 2112. The scheduler 2116 also updates CQ 2132 with the completion descriptors and EQ 2134 with the status of completion, which can generate a host CPU interrupt and/or an exception. In certain embodiments, TOE driver layer 2300 may coalesce the events and interrupts for efficient processing. This queuing mechanism enables events and interrupts to be coalesced for more efficient servicing by the CPU. The execution core 2200 also generates acknowledgement (ACK) headers as part of processing.

FIG. 24B illustrates operations 2410 for processing inbound packets in accordance with certain embodiments. Control begins at block 2412 with receipt of a packet from the NIC, which has performed some NIC processing. In block 2414, a splitter is used to separate the packet into header and payload data. In block 2416, the header data is forwarded to the scheduler 2116. In block 2418, the processing engine 2110 attempts to find a context for the packet in cache 2112. In block 2420, if the context is found in cache 2112, processing continues to block 2424, otherwise, processing continues to block 2422. In block 2422, a memory lookup is performed (e.g., is scheduled to be performed), and when the memory lookup is done, processing continues to block 2424. In block 2424, the context is retrieved into the working register 2204 from cache 2112. In block 2426, packet processing continues with the processing engine 2110 and DMA controller (transmit and receive queues 2164, 2162) performing processing in parallel. In block 2428, wrap up processing is performed (e.g., the CQ 2132 and EQ 2134 are updated). Note that the DMA controller uses transmit DMA data structure 2160 and receive DMA data structure 2162 for processing.

FIG. 24C illustrates processing by the TOE for outbound packets in accordance with certain embodiments. The host places doorbell descriptors in DBQ 2130. The doorbell contains pointers to transmit or receive descriptor buffers, which reside in host memory. The processing engine 2210 fetches and loads the descriptors in the cache 2112.

24D illustrates operations 2460 for processing outbound packets in accordance with certain embodiments. Control begins at block 2462 with receipt of a packet from a host via DBQ 2130. In block 2464, descriptors are fetched into cache 2112 from host memory using pointers in DBQ 2130 to access the host memory. In block 2466, a lookup for the context is scheduled. In block 2468, when the lookup is complete, the context is loaded into the working register 2204 from host memory. In block 2470, packet processing continues with the processing engine 2110 and DMA controller (transmit and receive queues 2164, 2162) performing processing in parallel. In block 2472, wrap up processing is performed (e.g., the CQ 2132 and EQ 2134 are updated).

Scheduling a lookup against the local cache 2112 identifies the connection with the corresponding connection context being loaded into the execution core 2200 working register 2204 (FIG. 22), starting execution core 2200 processing. The execution core 2200 programs the DMA control unit to queue the transmit DMA requests. This provides autonomous transfer of data from payload locations in host memory to internal transmit buffers using DMA. Processed results are written back to the cache 2112. Completion notification of a send is accomplished by populating CQ 2132 and EQ 2134 to signal end of transmit.

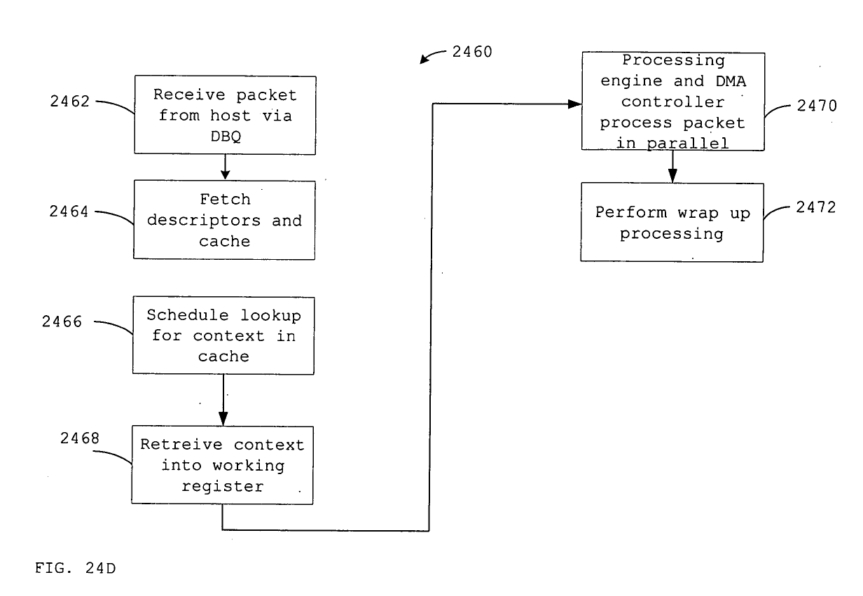

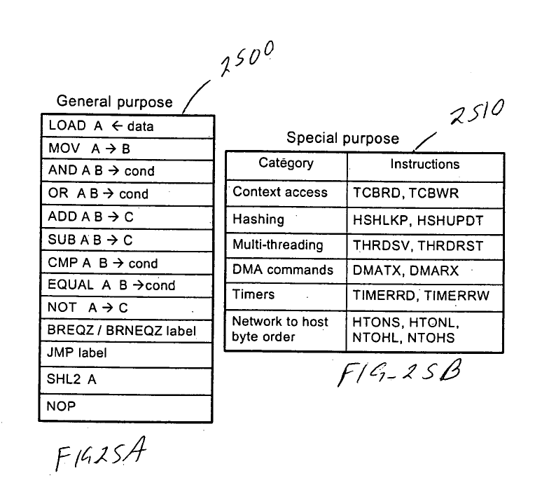

FIGS. 25A and 25B illustrate a new TOE instruction set in accordance with certain embodiments. In addition to the general purpose instructions 2500 supported by the TOE, a special purpose instructions 2510 are provided for TCP processing. The specialized instruction set includes special purpose instructions for accelerated context lookup, loading and write back. In certain embodiments, these instructions enable context loads and stores from cache 2112 in eight slow cycles, as well as 512 B wide context read and write between the working register 2204, which is in the execution core 2200, and the thread cache 2206 in a single core cycle. The special purpose instructions include single cycle hashing, DMA transmit and receive instructions and timer commands. Hardware assist for conversion between host and network byte order is also available. In certain embodiments, the generic instructions operate on 32 bit operands. The new special purpose instructions allow single cycle hashing (HSHLKP/HSHUPDT) and high bandwidth context loads and stores (TCBRD/TCBRW).

In FIG. 25B, the context access instructions allow reach of cache 2112 (TCBRD) and write of cache 2112 (TCBWR). The hashing instructions provide hash lookup (HSHLKP) and hash update (HSHUPDT). The multi-threading instructions enable a thread to be saved (THRDSV) from working register 2204 into thread cache 2206 or restored (THRDRST) from thread cache 2206 into working register 2204. The DMA instructions allow for DMA transfer (DMATX) and DMA receive (DMARX). The timers instructions allow reading of a timer (TIMERRD) and rewriting of a timer (TIMERRW). Also, network byte reordering support is available. For the network to host byte order instructions, HTONL convert host-to-network, long integer (32 bits); HTONS converts host-to-network, short integer (16 bits); NTOHL converts network-to-host, long integer (32 bits); and, NTOHS converts network-to-host, short integer (16 bits).

Certain embodiments provide a multi-threaded system to enable hiding of latency from memory accesses and other hardware functions, and, thus, expedites inbound and outbound packet processing, minimizing the need for buffering and queuing. Unlike conventional approaches to multi-threading, certain embodiments implement the multiple thread mechanism in hardware, including thread suspension, scheduling, and save/restore of thread state. This frees a programmer from the responsibility of maintaining and scheduling threads and removes the element of human error. The programming model is thus far simpler than the more common model of a programmer or compiler generating multithreaded code. Also, in certain embodiments, the save/restore of thread state and switching may be programmer controlled.

Additionally, code that runs on a single-threaded engine may run on the multi-threaded processing engine 2110, but with greater efficiency. The overhead penalty from switching between threads is kept minimal to achieve better throughput.

As can be seen in FIGS. 24A and 24C, there are several memory accesses as well as synchronization points with the DMA engine that can cause the execution core to stall while waiting for a response. Thread switches can happen on both transmit and receive processing. If execution core 2200 processing completes prior to DMA, thread switch can occur to improve throughput. When DMA ends, the thread switches back to update the context with processed results and the updated context is written back to the TCB.

Unlike conventional approaches, the scheduler 2116 controls the switching between different threads. A thread is associated with each network packet that is being processed, both incoming and outgoing. This differs from other approaches that associate threads with each task to be performed, irrespective of the packet. The scheduler 2116 spawns a thread when a packet belonging to a new connection needs to be processed. In certain embodiments, a second packet for that same connection may not be assigned a thread until the first packet is completely processed and the updated context has been written back to cache 2112. This is under the control of the scheduler 2116. When the processing of a packet in the execution core 2200 is stalled, the thread state is saved in the thread cache 2206, and the scheduler 2116 spawns a thread for a packet on a different connection. The scheduler 2116 may also wake up a thread for a previously suspended packet by restoring thread state and allowing the thread to run to completion. In this approach, the scheduler 2116 may also spawn special maintenance threads for global tasks (e.g., such as gathering statistics on Ethernet traffic).

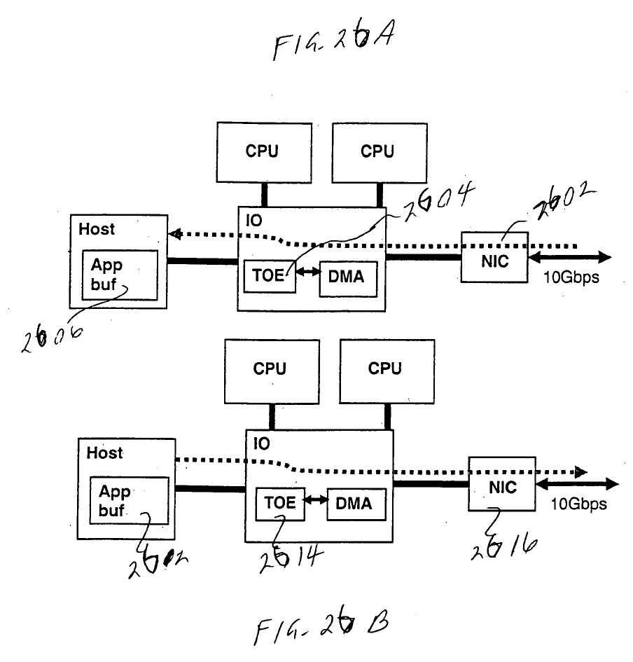

FIGS. 26A and 26B illustrate TOE assisted DMA data transfer on packet receive (FIG. 26A) and packet transmit (FIG. 26B) in accordance with certain embodiments. In FIG. 26A, a packet is received at NIC 2602, passes through TOE 2604 to a host application buffer 2606. In FIG. 26B, a packet is transmitted from host application buffer 2612, through TOE 2614, to NIC 2616.

Thus, the network protocol processing system also provides a low power/high performance solution with better Million Instructions Per Second (MIPS)/Watt than a general purpose CPU. Thus, certain embodiments provide packet processing that demonstrates TCP termination for multi-gigabit Ethernet traffic. With certain embodiments, performance analysis shows promise for achieving line speed TCP termination at 10 Gbps duplex rates for packets larger than 289 bytes, which is more than twice the performance of a single threaded design. In certain embodiments, the network protocol processing system complies with the Request for Comments (RFC) 793 TCP processing protocol, maintained by the Internet Engineering Task Force (IETF).

Certain embodiments minimize intermediate copies of payload. Conventional systems use intermediate copies of data during both transmits and receives, which results in a performance bottleneck. In conventional systems, data to be transmitted is copied from the application buffer to a buffer in OS kernel space. It is then moved to buffers in the NIC before being sent out on the network. Similarly, data that is received has to be first stored in the NIC, then moved to kernel space and finally copied into the destination application buffers. On the other hand, embodiments pre-assign buffers for data that are expected to be received to facilitate efficient data transfer.

Certain embodiments mitigate the effect of memory accesses. Processing transmits and receives requires accessing context data for each connection that may be stored in host memory. Each memory access is an expensive operation, which can take up to 100 ns. Certain embodiments optimize the TCP stack to reduce the number of memory accesses to increase performance. At the same time, certain embodiments use techniques to hide memory latency.

Certain embodiments provide quick access to state information. The context data for each Ethernet connection may be of the order of several hundred bytes. Caching the context for active connections is provided. In certain embodiments, caching context for a small number of connections (burst mode operation) is provided and results in performance improvement. In certain embodiments, the cache size is made large enough to hold the allowable number of connections. Additionally, protocol processing may require frequent and repeated access to various fields of each context. Certain embodiments provide fast local registers to access these fields quickly and efficiently to reduce the time spent in protocol processing. In addition to context data, these registers can also be used to store intermediate results during processing.

Certain embodiments optimize instruction execution. In particular, certain embodiments reduce the number of instructions to be executed by optimizing the TCP stack to reduce the processing time per packet.

Certain embodiments streamline interfaces between the host, chipset and NIC. This addresses a source of overhead that reduces host efficiency because of the communication interface between the host and NIC. For instance, an interrupt driven mechanism tends to overload the host and adversely impact other applications running on the host.

Certain embodiments provide hardware assist blocks for specific functions, such as hardware blocks for encryption/decryption, classification, and timers.

Certain embodiments provide a multi-threading architecture to effectively hide host memory latency with a controller being implemented in hardware. Certain embodiments provide a mechanism for high bandwidth transfer of context between the working register and the thread cache, allowing fast storage and retrieval of context data. Also, this avoids the processor from stalling and hides processing latency.

Intel is a registered trademark and/or common law mark of Intel Corporation in the United States and/or foreign countries.

### Additional Embodiment Details

The described techniques for adaptive caching may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art recognize that many modifications may be made to this configuration without departing from the scope of embodiments, and that the article of manufacture may comprise any information bearing medium known in the art.

Although the term “queue” may be used to refer to data structures for certain embodiments, other embodiments may utilize other data structures. Although the term “cache” may be used to refer to storage areas for certain embodiments, other embodiments may utilize other storage areas.

The illustrated logic of FIGS. 11, 24B, and 24D show certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

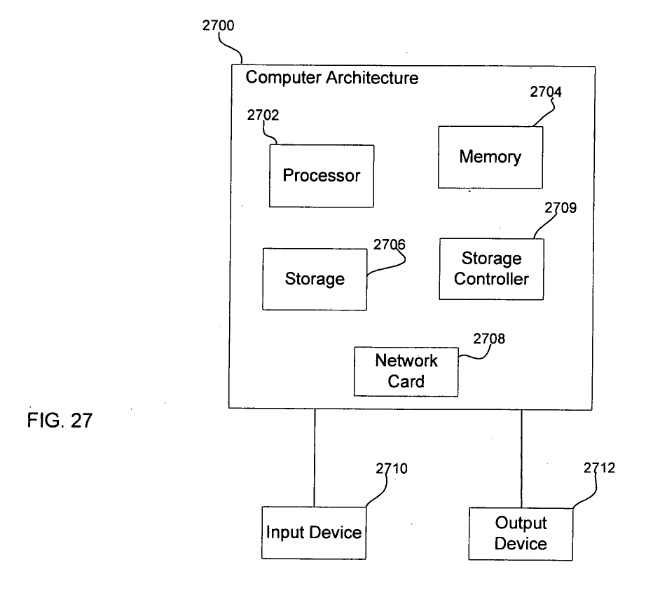

FIG. 27 illustrates one embodiment of a computing device 2700. For example, a host may implement computing device 2700. The computing device 2700 may include a processor 2702 (e.g., a microprocessor), a memory 2704 (e.g., a volatile memory device), and storage 2706 (e.g., a non-volatile storage, such as magnetic disk drives, optical disk drives, a tape drive, etc.). The storage 2706 may comprise an internal storage device or an attached or network accessible storage. Programs in the storage 2706 are loaded into the memory 2704 and executed by the processor 2702 in a manner known in the art. The system further includes a network card 2708 to enable communication with a network, such as an Ethernet, a Fibre Channel Arbitrated Loop (IETF RFC 3643, published December 2003), etc. Further, the system may, in certain embodiments, include a storage controller 2709. As discussed, certain of the network devices may have multiple network cards. An input device 2710 is used to provide user input to the processor 2702, and may include a keyboard, mouse, pen-stylus, microphone, touch sensitive display screen, or any other activation or input mechanism known in the art. An output device 2712 is capable of rendering information transmitted from the processor 2702, or other component, such as a display monitor, printer, storage, etc.

The foregoing description of various embodiments has been presented for the purposes of illustration and description. It is not intended to be exhaustive or to limit the embodiments to the precise forms disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments can be made without departing from the spirit and scope of the embodiments, the embodiments reside in the claims hereinafter appended.

1. A network protocol processor system, the system comprising:
an interface to receive a packet;
a cache to store context data for the packet; and
a processing engine to process the packet using context data in the cache.

2. The system of claim 1, further comprising:
a working register to store the context data for a current connection that is being processed.

3. The system of claim 1, wherein the cache is capable of storing and retrieving context data for multiple connections.

4. The system of claim 1, wherein the interface comprises at least one of a host interface and a network interface.

5. The system of claim 4, wherein the host interface interacts with a doorbell queue, a completion queue, and an exception/event queue.

6. The system of claim 5, wherein each of the doorbell queue, the completion queue, and the exception/event queue is a data structure.

7. The system of claim 6, wherein each data structure has a priority mechanism.

8. The system of claim 5, further comprising:
processing logic to store the packet incoming from the host interface into the doorbell queue;
host memory to store descriptors that are pointed to by the packet;
processing logic to access the descriptors in host memory for storage in the cache; and
a scheduler to perform a hash based table lookup against the cache to correlate the packet with context data, to load the context into the working register when the context data is found in the cache, and to schedule a host memory lookup when the context data is not found in cache.

9. The system of claim 8, further comprising:
a Direct Memory Access (DMA) controller; and
processing logic to notify the DMA controller to transfer data from host memory to the transfer queue.

10. The system of claim 5, wherein the DMA controller is capable of storing data from the header and data queue into host memory.

11. The system of claim 4, wherein the network interface interacts with a header and data queue and a transmit queue.

12. The system of claim 11, further comprising:
processing logic to store the packet incoming from the network interface into the header and data queue;
a working register;
a scheduler to perform a hash based table lookup against the cache to correlate the packet with context data, to load the context into the working register when the context data is found in the cache, and to schedule a host memory lookup when the context data is not found in cache.

13. The system of claim 1, further comprising:
a working register to store data for use by the processing engine; and
a scheduler to locate and load the context data into the working register.

14. The system of claim 1, further comprising:
a Direct Memory Access transfer queue; and
a Direct Memory Access receive queue.

15. The system of claim 1, further comprising:
a timer; and
a hardware assist to translate a virtual address to a physical address.

16. The system of claim 1, further comprising:
a thread cache to store intermediate system state;
a core receive queue;
a working register;
scratch registers;
a pieplined arithmetic logic unit; and
an instruction cache.

17. The system of claim 16, further comprising:
a high bandwidth connection between the thread cache and the working register for parallel transfer of intermediate system state between the thread cache and the working register.

18. The system of claim 1, further comprising:
an instruction cache to store code relevant to specific processing, while remaining instructions are stored in at least one of host memory and cache to store context data.

19. The system of claim 1, further comprising a new instruction set including context access instructions, hashing instructions, multi-threading instructions, Direct Memory Access instructions, timer instructions, and network to host byte order instructions.

20. The system of claim 1, further comprising:
a scheduler coupled to the cache;
a working register coupled to the cache; and
processing logic in the processing engine to store context data in the working register into the storage area when processing of the packet has stalled.

21. The system of claim 20, wherein the packet is a first packet and further comprising:
processing logic to load context data for a second packet from the storage area into the working register.

22. The system of claim 21, further comprising:
processing logic to restore the context data for the packet into the working register.

23. The system of claim 1, further comprising:
a Direct Memory Access (DMA) controller coupled to the processing logic, wherein the DMA controller is capable of transferring data independently while the processing engine continues context processing in parallel.

24. A network protocol processor system, the system comprising:
a first interface to receive a first packet, wherein the first interface is coupled to a source of a first clock signal having a first frequency;
a second interface to receive a second packet, wherein the second interface is coupled to a source of the first clock signal having the first frequency;
processing logic to process the first packet and the second packet, wherein at least one component of the processing logic is coupled to a second clock signal having a second frequency different than the first frequency.

25. The system of claim 24, wherein the second frequency is higher than the first frequency.

26. The system of claim 24, further comprising:
a computing device coupled to the first interface; and
a network interface controller coupled to the second interface.

27. The system of claim 24, further comprising:
a storage area to store context data for at least one packet;
a subset of the storage area to store context data for one packet; and
processing logic to retrieve context data for the first packet, wherein the subset of the storage area is coupled to the processing logic.

28. A method for processing a packet, comprising:
receiving a packet;
locating context data for the packet in a storage area; and
processing the packet using the context data.

29. The method of claim 28, further comprising:
performing a lookup against the storage area to correlate the packet with context data;
loading the context into a working register in response to locating the context data in the storage area; and
scheduling a lookup of context data in response to determining that the context data is not in the storage area.

30. The method of claim 29, further comprising:
storing context data from the working register into the storage area when processing of the packet has stalled.

31. The method of claim 29, further comprising:
updating process results to the working register;
updating the storage area with the results in the working register; and
updating a thread area with the results in the working register.

32. The method of claim 31, wherein the packet is a first packet and further comprising:
loading context data for a second packet from the storage area into the working register.

33. The method of claim 32, further comprising:
restoring the context data for the first packet into the working register.

34. An article of manufacture comprising a storage medium having stored therein instructions that when executed by a computing device results in the following:
receiving a packet;
locating context data for the packet in a storage area; and
processing the packet using the context data.

35. The article of manufacture of claim 34, wherein the instructions when executed further result in the following:
performing a lookup against the storage area to correlate the packet with context data;
loading the context into a working register in response to locating the context data in the storage area; and
scheduling a lookup of context data in response to determining that the context data is not in the storage area.

36. The article of manufacture of claim 35, wherein the instructions when executed further result in the following:
storing context data from the working register into the storage area when processing of the packet has stalled.

37. The article of manufacture of claim 36, wherein the instructions when executed further result in the following:
updating process results to the working register;
updating the storage area with the results in the working register; and
updating a thread area with the results in the working register.

38. The article of manufacture of claim 37, wherein the packet is a first packet and wherein the instructions when executed further result in the following:
loading context data for a second packet from the storage area into the working register.

39. The article of manufacture of claim 38, wherein the instructions when executed further result in the following:
restoring the context data for the first packet into the working register.
